(19) United States
(12) Patent Application Publication
(10) Pub. No.: US 2016/0291666 A1
(43) Pub. Date: Oct. 6, 2016

(54) DISPLAY APPARATUS AND DISPLAY APPARATUS CONTROL METHOD

(71) Applicant: SEIKO EPSON CORPORATION, Tokyo (JP)

(72) Inventors: Yoshinori HOSOYA, Okaya-shi (JP); Yutaka FUJIMAKI, Matsumoto-shi (JP); Kenro YAJIMA, Matsumoto-shi (JP)

(73) Assignee: SEIKO EPSON CORPORATION, Tokyo (JP)

(21) Appl. No.: 15/052,163

(22) Filed: Feb. 24, 2016

(30) Foreign Application Priority Data
Mar. 30, 2015 (JP) 2015-067896

(51) Int. Cl. G06F 1/28; G09G 5/377

(52) U.S. Cl. CPC G06F 1/28; G09G 5/377; G09G 2340/12; G09G 2330/021

(57) ABSTRACT

An HMD includes an image display unit, which causes a user to visually recognize an image and causes an external view to be transmitted, a first battery, and a second battery. In addition, when the remaining power quantity of any one of the batteries becomes the remaining power quantity which requires exchange, the HMD maintains the display state of the HMD, and causes the image display unit to display guidance information relevant to the HMD such that the guidance information overlaps at least a part of the HMD, which is visually recognized as the external view.

### BACKGROUND

1. Technical Field

The present invention relates to a display apparatus and a display apparatus control method.

2. Related Art

In the related art, a technology in which a plurality of batteries are mounted on a display apparatus has been known (for example, refer to JP-A-2013-137408). In JP-A-2013-137408, batteries are provided in a mobile display apparatus, the batteries are provided in a power control unit which is connected to the mobile display apparatus, and batteries to be used as a power source are selectively switched according to the remaining power quantities of the batteries.

The apparatus disclosed in JP-A-2013-137408 performs charging when the remaining power quantities of the batteries are small, and thus it is not expected that a user takes the remaining power quantities of the batteries into consideration. However, when the remaining power quantities of the batteries are small, it is possible to rapidly restore the remaining power quantities, and thus it is useful to exchange the batteries. As disclosed in JP-A-2013-137408, when the power source is controlled according to the remaining power quantities of a plurality of batteries, it is difficult for the user to realize the remaining power quantities of the respective batteries. Therefore, it is difficult to estimate battery exchanging time or the batteries to be exchanged. Accordingly, it is desired to rapidly provide information relevant to battery exchange to the user.

### SUMMARY

An advantage of some aspects of the invention is to rapidly provide information relevant to battery exchange to a user in a display apparatus which includes a plurality of batteries.

A display apparatus according to an aspect of the invention is provided with a display unit that causes a user to visually recognize an image and causes an external view to be transmitted, and includes: a plurality of batteries; and a control unit that, when a remaining power quantity of any one of the batteries becomes a remaining power quantity which requires exchange, maintains a display state of the display apparatus, and causes the display unit to display guidance information relevant to the display apparatus such that the guidance information overlaps at least a part of the display apparatus, which is visually recognized as the external view, while maintaining a power source of the display apparatus.

In the display apparatus according to the aspect of the invention, when the remaining power quantity of the battery is the remaining power quantity which requires exchange, the guidance information is displayed to overlap the display apparatus, which is visually recognized as the external view, in actual space, and thus it is possible to provide various types of information, such as the necessity for battery exchange or an exchange procedure, to the user.

Here, the guide information may include, for example, state information, such as the remaining power quantity relevant to at least a part of the plurality of batteries, and guidance display for guiding the necessity for battery exchange, an exchange procedure, an exchange operation method, the time in which it is possible to continuously use the batteries, or the like. However, other information may be used. In addition, a configuration in which the display state is maintained when the batteries are exchanged is included. However, other configurations may be included. In addition, the meaning that the display state is maintained is that information to be displayed is held as the same information. For example, if a state in which it is possible to display information is maintained, the display state is maintained even when the information to be displayed is changed.

A display apparatus according to another aspect of the invention is provided with a display unit that causes a user to visually recognize an image and causes an external view to be transmitted, and includes: a battery; and a control unit that, when a remaining power quantity of the battery becomes a remaining power quantity which requires exchange, maintains a display state of the display apparatus, and causes the display unit to display internal information such that the internal information overlaps at least a part of the display apparatus which is visually recognized as the external view.

According to the aspect of the invention, when the remaining power quantity of the battery is the remaining power quantity which requires exchange, the internal information is displayed to overlap the display apparatus, which is visually recognized as the external view, in actual space, and thus it is possible to provide various types of information, such as the necessity for battery exchange or an exchange procedure, to the user.

Here, the internal information includes, for example, state information, such as the remaining power quantity relevant to at least a part of the plurality of batteries, and guidance display for guiding the necessity for battery exchange, the exchange procedure, the exchange operation method, the time in which it is possible to continuously use the batteries, or the like. However, other information may be used. In addition, a configuration in which the display state is maintained when the batteries are exchanged is included. However, other configurations may be included.

A display apparatus according to still another aspect of the invention is provided with a display unit that causes a user to visually recognize an image and causes an external view to be transmitted, and includes: a plurality of batteries; a remaining power quantity display unit that performs display according to a remaining power quantity of any one of the batteries; and a control unit that, when a remaining power quantity of any one of the batteries becomes a remaining power quantity which requires exchange, causes the remaining power quantity display unit to execute report display, and causes the display unit to perform guidance display for guiding exchange of the battery, the remaining power quantity of which requires exchange.

According to the aspect of the invention, when the report display is performed by the battery remaining power quantity display unit and the guidance display is performed by the display unit, it is possible for the user to be easily aware of the necessity for battery exchange. Accordingly, it is possible to rapidly provide the information relevant to battery exchange to the user.

According to these configurations, it is possible for the control unit to cause the display unit to perform display for guiding the exchange procedure without, for example, detaching all of the plurality of batteries. In this case, even when all of the plurality of batteries, which are included in the display apparatus, are in states which require exchange, it is possible to exchange the batteries without turning off the power source of the display apparatus, that is, without stopping the display apparatus. With the display, even when the user does not understand the battery exchange procedure, it is possible to exchange the batteries without stopping the display apparatus. Further, for example, if display for guiding the battery exchange procedure, a sequence of exchanging each of the batteries, or the like is performed according to the remaining power quantities of the respective batteries, which are acquired when the display is performed, it is possible for the user to exchange the batteries without stopping the display apparatus even when the time which is necessary to exchange the batteries is long.

In addition, a configuration may be provided in which, when display is performed according to at least any one of the remaining power quantities of the batteries, it is possible to perform display based on, for example, the average of the plurality of the remaining power quantities of the batteries. That is, it is possible to perform display according to at least any one of the remaining power quantities of the batteries or the average of all of the remaining power quantities of the batteries.

In the aspect of the invention, the control unit may detect a target, which transmits through the display unit and is visually recognized by the user, and may perform the guidance display in a location which overlaps the detected target and which is visually recognized.

According to the aspect of the invention with this configuration, when the user visually recognizes the target which is transmitted through the display unit, it is possible to effectively provide the information relevant to battery exchange.

In the aspect of the invention, the display apparatus may further include an electrical power supply unit that supplies electrical power to the display apparatus by the plurality of the batteries, and the control unit may determine that the remaining power quantity of any one of the batteries becomes the remaining power quantity which requires exchange based on a sum of the remaining power quantities of the plurality of the batteries.

According to the aspect of the invention with this configuration, it is possible to drive the display apparatus by effectively using the plurality of batteries.

In the aspect of the invention, the control unit may cause the display unit to perform the guidance display so as to synchronize with a change in a display state of the remaining power quantity display unit.

According to the aspect of the invention with this configuration, it is possible to further rapidly and securely inform the user that it is necessary to exchange the batteries.

In the aspect of the invention, when the plurality of the batteries are determined to have the remaining power quantities which require exchange, the control unit may cause the display unit to perform guidance display for guiding exchange of any one of the batteries.

According to the aspect of the invention with this configuration, it is possible to prevent a non-preferable situation in which all of the plurality of batteries are detached from occurring.

In the aspect of the invention, the remaining power quantity display unit may be provided to correspond to each of the plurality of the batteries, and the control unit may change the display state of the remaining power quantity display unit based on the remaining power quantity of each of the plurality of the batteries.

According to the aspect of the invention with this configuration, it is possible to provide information relevant to the remaining power quantities of the plurality of batteries to the user.

A method of controlling a display apparatus according to still another aspect of the invention is a method of controlling a display apparatus, which includes a plurality of batteries and a display unit that causes a user to visually recognize an image and causes an external view to be transmitted, the method including: when a remaining power quantity of any one of the batteries becomes a remaining power quantity which requires exchange, maintaining a display state of the display apparatus, and causing the display unit to display guidance information relevant to the display apparatus such that the guidance information overlaps at least a part of the display apparatus, which is visually recognized as the external view, while maintaining a power source of the display apparatus.

According to the aspect of the invention, when the remaining power quantity of the battery is the remaining power quantity which requires exchange, the guidance information is displayed to overlap the display apparatus, which is visually recognized as the external view, in actual space, and thus it is possible to provide various types of information, such as the necessity for battery exchange and the exchange procedure, to the user.

A method of controlling a display apparatus according to yet another aspect of the invention is a method of controlling a display apparatus, which includes a plurality of batteries and a display unit that causes a user to visually recognize an image and causes an external view to be transmitted, the method including: when remaining power quantities of the batteries become remaining power quantities which require exchange, maintaining a display state of the display apparatus, and causing the display unit to display internal information such that the internal information overlaps at least a part of the display apparatus which is visually recognized as the external view.

According to the aspect of the invention, when the remaining power quantity of the battery is the remaining power quantity which requires exchange, the internal information is displayed to overlap the display apparatus, which is visually recognized as the external view, in actual space, and thus it is possible to provide various types of information, such as the necessity for battery exchange and the exchange procedure, to the user.

A method of controlling a display apparatus according to still yet another aspect of the invention is a method of controlling a display apparatus, which includes a plurality of batteries, a remaining power quantity display unit that performs display according to a remaining power quantity of any one of the batteries, and a display unit that causes a user to visually recognize an image and causes an external view to be transmitted, the method including: when a remaining power quantity of any one of the batteries becomes a remaining power quantity which requires exchange, causing the remaining power quantity display unit to execute report display, and causing the display unit to perform guidance display for guiding exchange of the battery, the remaining power quantity of which requires exchange.

According to the aspect of the invention, the report display is performed by the battery remaining power quantity display unit and the guidance display is performed by the display unit, and thus it is possible for the user to be easily aware of the necessity for battery exchange. Accordingly, it is possible to rapidly provide the information relevant to battery exchange to the user.

### BRIEF DESCRIPTION OF THE DRAWINGS

The invention will be described with reference to the accompanying drawings, wherein like numbers reference like elements.

FIG. 1 is an explanatory diagram illustrating the appearance configuration of an HMD.

FIG. 2 is a block diagram illustrating the functions of respective units which are included in the HMD.

FIG. 3 is a circuit diagram illustrating an example of the configuration of a power source unit.

FIGS. 4A and 4B are diagrams illustrating the appearances of a main body of a control device.

FIG. 5 is an explanatory diagram illustrating the transition of the state of the HMD.

FIGS. 6A to 6D are explanatory diagrams illustrating examples of display pertaining to the exchange of a battery.

FIG. 7 is a flowchart illustrating the operation of the HMD.

FIG. 8 is a flowchart illustrating the operation of the HMD.

### DESCRIPTION OF EXEMPLARY EMBODIMENTS

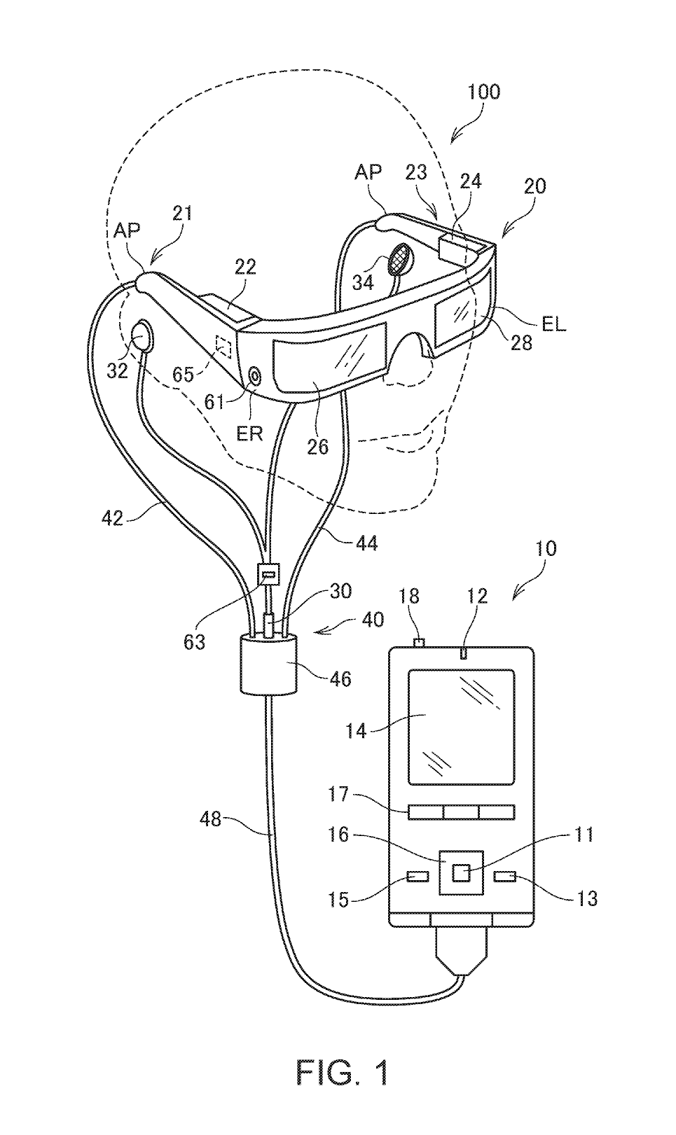

FIG. 1 is an explanatory diagram illustrating the appearance configuration of an HMD 100. The HMD 100 is a display apparatus which is mounted on a head, and is called a head mounted display (head mounted-type display apparatus). The HMD 100 according to an embodiment is an optical transmission-type display apparatus in which a user can directly visually recognize an external view at the same time that the user visually recognizes a virtual image. Meanwhile, in the specification, the virtual image which is visually recognized by the user using the HMD 100 is called a “display image” for convenience. In addition, an operation in which image light generated based on image data is emitted means that “an image is displayed”.

The HMD 100 includes an image display unit 20 (display unit) which causes the user to visually recognize a virtual image while being mounted on the head of the user, and a control device 10 which controls the image display unit 20. The control device 10 functions as a controller such that the user operates the HMD 100.

The image display unit 20 is a mounting body which is mounted on the head of the user, and has a shape of glasses in the embodiment. The image display unit 20 includes a right holding unit 21, a right display driving unit 22, a left holding unit 23, a left display driving unit 24, a right optical image display unit 26, a left optical image display unit 28, a camera 61, and a microphone 63. The right optical image display unit 26 and the left optical image display unit 28 are arranged to be located in front of the right and left eyes of the user when the image display unit 20 is mounted on the user. One end of the right optical image display unit 26 and one end of the left optical image display unit 28 are connected to each other in a location corresponding to the middle of the forehead of the user when the image display unit 20 is mounted on the user.

The right holding unit 21 is a member which is provided to extend from an end part ER, which is the other end of the right optical image display unit 26, to the location corresponding to the temporal part of the user when the image display unit 20 is mounted on the user. In the same manner, the left holding unit 23 is a member which is provided to extend from an end part EL, which is the other end of the left optical image display unit 28, to the location corresponding to the temporal part of the user when the image display unit 20 is mounted on the user. The right holding unit 21 and the left holding unit 23 hold the image display unit 20 on the head of the user as temples (connections) of glasses.

The right display driving unit 22 and the left display driving unit 24 are arranged on the side which faces the head of the user when the image display unit 20 is mounted on the user. Meanwhile, the right display driving unit 22 and the left display driving unit 24 are collectively called a “display driving unit”, and the right optical image display unit 26 and the left optical image display unit 28 are collectively called an “optical image display unit”.

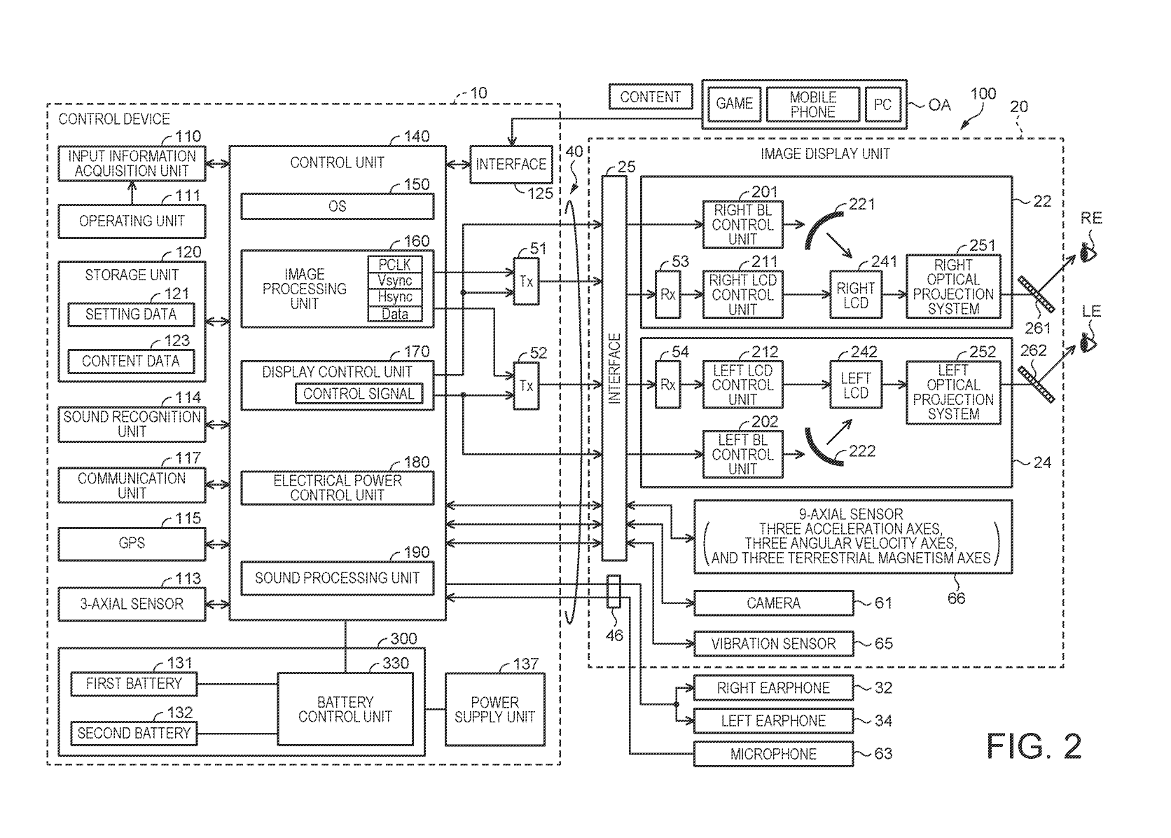

The display driving units 22 and 24 include liquid crystal displays 241 and 242 (hereinafter, referred to as “LCDs 241 and 242”), optical projection systems 251 and 252, and the like (refer to FIG. 2). The configurations of the display driving units 22 and 24 will be described in detail later. Optical image display units 26 and 28, which function as optical members, include light guiding plates 261 and 262 (refer to FIG. 2). The light guiding plates 261 and 262 are formed of light transmitting type resins or the like, and guide image light, which is output from the display driving units 22 and 24, to the eyes of the user. In the embodiment, a case in which the user who mounts the HMD 100 uses the right optical image display unit 26 and the left optical image display unit 28 which have light transmittance to a degree in which it is possible to visually recognize an external scene.

A camera 61 is arranged at the end part ER in the other end of the right optical image display unit 26. The camera 61 images an external view, which is an external scene in a direction opposite to the side of the eye of the user, and acquires an external view image. The camera 61 according to the embodiment illustrated in FIG. 1 is an ocellar camera. However, the camera 61 may be a stereo camera.

The photographing direction, that is, an angle of view of the camera 61 is a direction in which at least a part of an external view in a front side direction of the HMD 100, in other words, the visual field direction of the user in a state in which the HMD 100 is mounted is photographed. In addition, although the width of the angle of view of the camera 61 can be appropriately set, it is preferable that the imaging range of the camera 61 is a range which includes an external world which is visually recognized by the user through the right optical image display unit 26 and the left optical image display unit 28. Further, it is further preferable to set the imaging range of the camera 61 such that it is possible to photograph the entirety of the visual field of the user through the right optical image display unit 26 and the left optical image display unit 28.

The image display unit 20 further includes a connection unit 40 which connects the image display unit 20 to the control device 10. The connection unit 40 includes a main body code 48 for connecting the control device 10, a right code 42, a left code 44, and a connection member 46. The right code 42 and the left code 44 are codes which are acquired in such a way that the main body code 48 is branched into two parts. The right code 42 is inserted from the tip part AP of the right holding unit 21 in the extension direction into the housing of the right holding unit 21, and is connected to the right display driving unit 22. In the same manner, the left code 44 is inserted from the tip part AP of the left holding unit 23 in the extension direction into the housing of the left holding unit 23, and is connected to the left display driving unit 24.

The connection member 46 is provided at the branching point of the main body code 48, the right code 42, and the left code 44, and includes a jack for connecting to an earphone plug 30. A right earphone 32 and a left earphone 34 are extended from the earphone plug 30. The microphone 63 is provided in the vicinity of the earphone plug 30. A region from the earphone plug 30 to the microphone 63 is gathered into a single code. The code is branched from the microphone 63, and is linked to each of the right earphone 32 and the left earphone 34.

For example, as illustrated in FIG. 1, the microphone 63 is arranged such that the sound collection unit of the microphone 63 faces the gaze direction of the user, collects sounds, and outputs a sound signal to a sound processing unit 190. The microphone 63 may be, for example, a monaural microphone or a stereo microphone, or may be a directional microphone or a non-directional microphone.

In addition, it is possible to gather the right code 42 and the left code 44 into a single code. Specifically, a lead wire in the inside of the right code 42 may be drawn into the side of the left holding unit 23 through the inside of the main body of the image display unit 20, and may be covered by resin together with a lead wire in the inside of the left code 44, thereby being gathered into a single code.

The image display unit 20 and the control device 10 transmit various types of signals through the connection unit 40. Connectors (not shown in the drawing), which are fit to each other, are provided at the end part of the main body code 48 on a side opposite to the connection member 46 and the control device 10, respectively. The control device 10 is connected to or separated from the image display unit 20 in such a way that fitting/fitting release is performed on the connector of the main body code 48 and the connector of the control device 10. It is possible to use, for example, a metal cable or an optical fiber for the right code 42, the left code 44, and the main body code 48.

The control device 10 is a device which controls the HMD 100. The control device 10 includes switches that have a determination key 11, a lighting part 12, a display switching key 13, a brightness switching key 15, a direction key 16, menu keys 17, and a power source switch 18. In addition, the control device 10 includes a track pad 14 which performs a touch operation by the fingers of the user.

The determination key 11 detects a pushing operation, and outputs a signal which is used to determine content operated in the control device 10. The lighting part 12 notifies the operating state of the HMD 100 based on a light emitting state. The operating state of the HMD 100 includes, for example, ON/OFF of the power source. For example, a Light Emitting Diode (LED) is used as the lighting part 12. The display switching key 13 detects a pushing operation, and outputs, for example, a signal for switching the display mode of a content moving image between 3D and 2D.

The track pad 14 detects the operation of the fingers of the user on the operating surface of the track pad 14, and outputs a signal according to detected content. It is possible to use various track pads, such as an electrostatic type track pad, a pressure detection type track pad, or an optical type track pad, as the track pad 14. The brightness switching key 15 detects a pushing operation, and outputs a signal for increasing or decreasing the brightness of the image display unit 20. The direction key 16 detects pushing operations performed on keys corresponding to the up and down and the left and right directions, and outputs a signal according to detected content. The power source switch 18 detects the slide operation of a switch and switches the power source supplying states of the HMD 100.

FIG. 2 is a block diagram illustrating the functions of respective units which are included in the HMD 100.

As illustrated in FIG. 2, the HMD 100 is connected to external equipment OA through an interface 125. The interface 125 is an interface for connecting various types of external equipment OA, which are content supply sources, to the control device 10. It is possible to use, for example, an interface corresponding to a wired connection, such as a USB interface, a micro USB interface, or a memory card interface, as the interface 125.

The external equipment OA is used as an image supply device which supplies an image to the HMD 100. For example, a Personal Computer (PC), a mobile telephone terminal, a game terminal, or the like is used as the external equipment OA.

The control device 10 of the HMD 100 includes a control unit 140, an operating unit 111, an input information acquisition unit 110, a storage unit 120, a transmission unit (Tx) 51, and a transmission unit (Tx) 52.

The operating unit 111 detects an operation performed by the user. The operating unit 111 includes each of the units, that is, the determination key 11, the display switching key 13, the track pad 14, the brightness switching key 15, the direction key 16, the menu keys 17, and the power source switch 18 which are illustrated in FIG. 1.

The input information acquisition unit 110 acquires a signal according to operational input performed by the user. The signal according to the operational input includes, for example, the operational inputs for the track pad 14, the direction key 16, and the power source switch 18.

The storage unit 120 is anon-volatile storage device, and stores various computer programs. In addition, the storage unit 120 may store image data to be displayed on the image display unit 20 of the HMD 100.

In addition, the control unit 140 is connected with a 3-axial sensor 113, a GPS 115, a communication unit 117, and a sound recognition unit 114. The 3-axial sensor 113 is an acceleration sensor for three axes, and the control unit 140 is capable of acquiring a detection value acquired by the 3-axial sensor 113. The GPS 115 includes antennas (not shown in the drawing), receives Global Positioning System (GPS) signals, and acquires the current location of the control device 10. The GPS 115 outputs the current location and current time, which are acquired based on the GPS signals, to the control unit 140. In addition, the GPS 115 may include functions of acquiring the current time based on information which is included in the GPS signals, and correcting time which is clocked by the control unit 140 of the control device 10.

The communication unit 117 performs wireless data communication in compliance with the standards of wireless communication such as wireless LAN (WiFi (registered trademark)) or Miracast (registered trademark). In addition, the communication unit 117 is capable of performing wireless data communication in compliance with the standards of short distance wireless communication such as Bluetooth (registered trademark), Bluetooth Low Energy, RFID, and Felica (registered trademark).

When the external equipment OA is wirelessly connected to the communication unit 117, the control unit 140 acquires content data from the communication unit 117, and performs control to display an image on the image display unit 20. In contrast, when the external equipment OA is connected to the interface 125 in a wired manner, the control unit 140 acquires content data from the interface 125, and performs control to display an image on the image display unit 20. Accordingly, the communication unit 117 and the interface 125 are collectively referred to as a data acquisition unit DA hereinafter.

The data acquisition unit DA acquires the content data from the external equipment OA. The data acquisition unit DA acquires the data of an image, which is displayed by the HMD 100, from the external equipment OA.

The sound recognition unit 114 collects sound from the microphone 63, extracts features from digital sound data, which is acquired through conversion into digital data by a sound processing unit 190 which will be described later, and simulates the features. The sound recognition unit 114 individually recognizes the voices of a plurality of people by extracting and simulating the features of sound, and performs speaker recognition for specifying a person who is speaking for each voice and text conversion in which sound is converted into text. In addition, the sound recognition unit 114 may be configured to be capable of identifying the type of language of sound data in a sound recognition process.

The control unit 140 includes a CPU, a ROM, a RAM (not shown in the drawing), and the like as hardware. The control unit 140 reads and executes a computer program which is stored in the storage unit 120, thereby functioning as an Operating System (OS) 150, an image processing unit 160, a display control unit 170, an electrical power control unit 180 (control unit), and the sound processing unit 190.

The HMD 100 includes a normal operation mode and a battery exchange mode as operation modes. The switching of the operation modes of the HMD 100 is performed by the electrical power control unit 180.

The normal operation mode is an operation mode in which electrical power is supplied to each of the functional blocks of the HMD 100, and electrical power is supplied from a power source unit 300 to at least the control unit 140, the communication unit 117, and the right display driving unit 22 and the left display driving unit 24 of the image display unit 20. In addition, in the normal operation mode, it is possible to supply electrical power to all the functional blocks of the HMD 100 illustrated in FIG. 2. However, it is not required that all the functional blocks should be simultaneously energized.

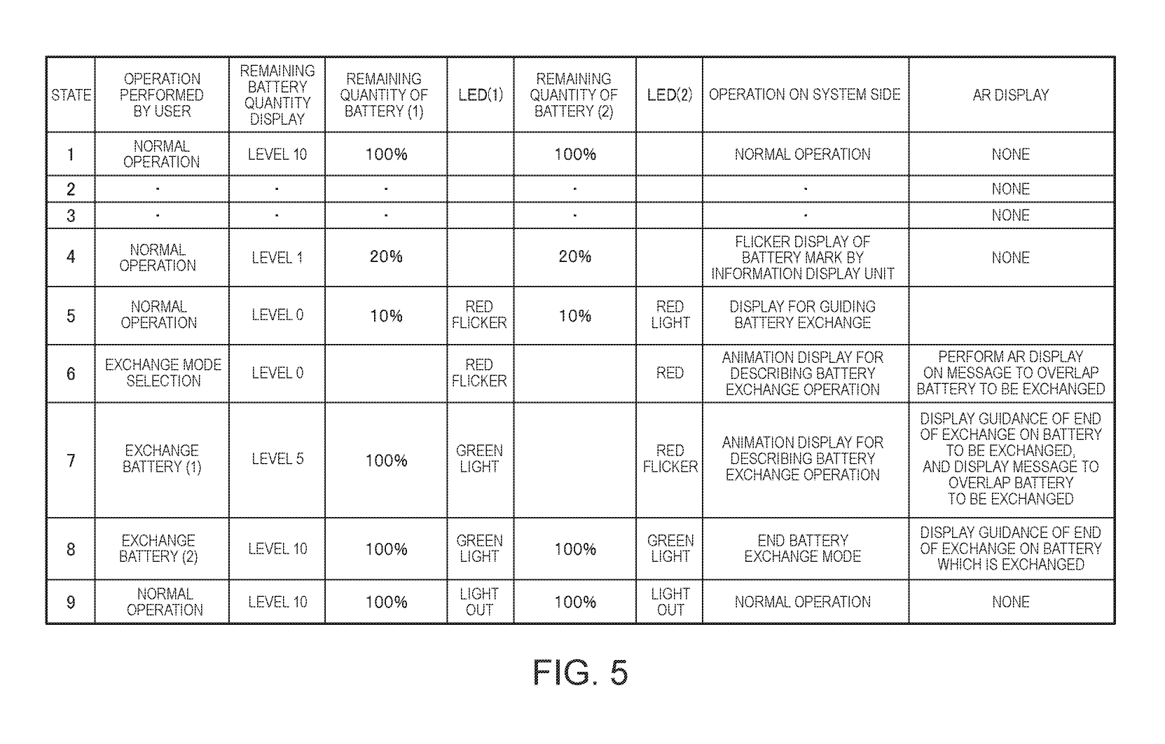

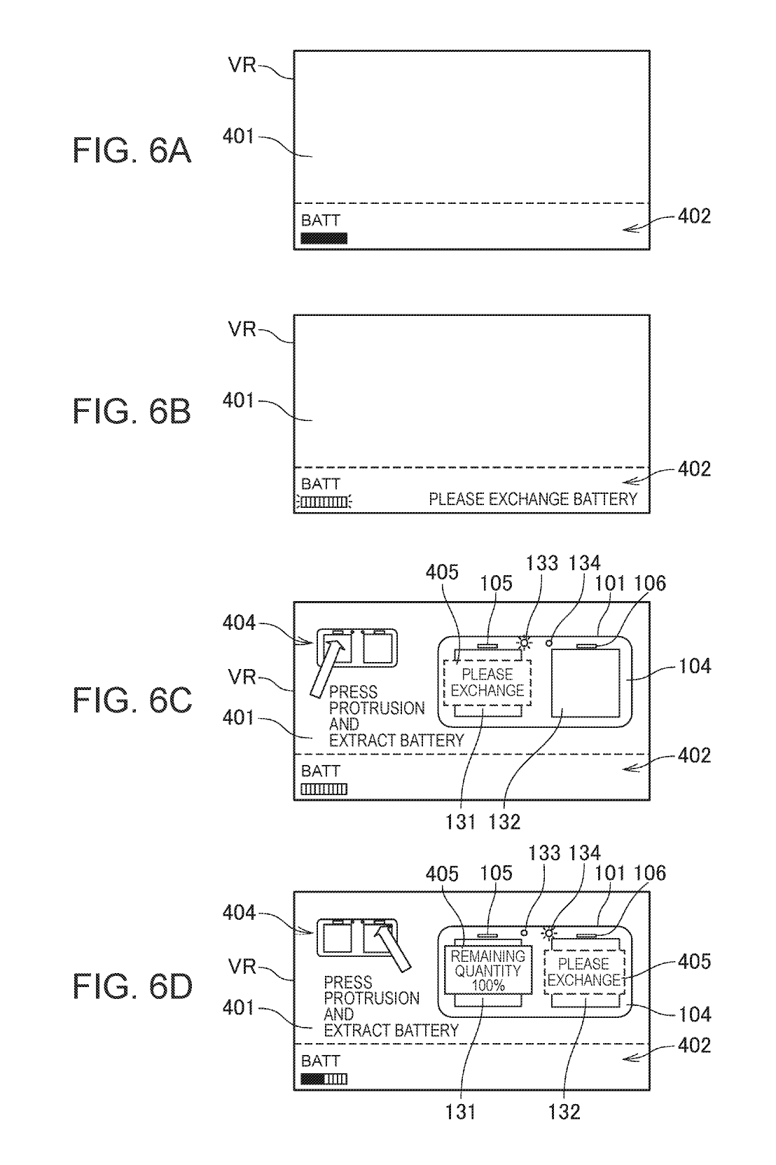

The battery exchange mode is an operation mode in which a first battery 131 or a second battery 132 is exchanged. In the embodiment, as will be described later with reference to FIG. 5 and FIGS. 6A to 6D, the battery exchange mode is an operation mode in which the electrical power control unit 180 controls the display state of the image display unit 20, and the other operations are the same as in the normal operation mode. For example, a state in which power is supplied to each of the units of the HMD 100 from the power source unit 300 is the same. Meanwhile, in the battery exchange mode according to the embodiment, in preparation for the exchange of the first battery 131 and the second battery 132, the electrical power control unit 180 may perform control to suppress the amount of electrical power consumption of the HMD 100. For example, the electrical power control unit 180 may limit the electrical power supply destination of the power source unit 300 such that electrical power is supplied to, for example, the control unit 140, the communication unit 117, and the right display driving unit 22 and the left display driving unit 24 of the image display unit 20.

The image processing unit 160 outputs image data (Data in the drawing), such as a vertical synchronizing signal VSync, a horizontal synchronizing signal HSync, and a clock signal PCLK, of an image to be displayed in order to display content.

The image data of content, which is displayed according to a process performed by the image processing unit 160, may be image data which is generated by a process performed by the control unit 140 in addition to image data which is received through the interface 125 and the communication unit 117. For example, when a game application program is being executed, it is possible to generate and display image data corresponding to an operation performed by the operating unit 111.

Meanwhile, the image processing unit 160 may perform an image process, such as a resolution conversion process, a various color tone correction process including brightness and saturation adjustment, and keystone correction, on the image data as necessary.

The image processing unit 160 transmits each of the generated clock signal PCLK, the vertical synchronizing signal VSync, the horizontal synchronizing signal HSync, and the image data Data, which is stored in a DRAM in the storage unit 120, through the transmission units 51 and 52. Meanwhile, the image data Data, which is transmitted through the transmission unit 51, is called “right eye image data”, and the image data Data, which is transmitted through the transmission unit 52, is called “left eye image data”. The transmission units 51 and 52 function as transceivers for performing serial transmission between the control device 10 and the image display unit 20.

The display control unit 170 generates a control signal for controlling the right display driving unit 22 and the left display driving unit 24. Specifically, the display control unit 170 individually performs control such that the driving of a right LCD 241 is turned ON/OFF by a right LCD control unit 211 and the driving of a right backlight 221 is turned ON/OFF by a right backlight control unit 201 based on the control signal. In addition, the display control unit 170 individually performs control such that the driving of a left LCD 242 is turned ON/OFF by a left LCD control unit 212 and the driving of a left backlight 222 is turned ON/OFF by a left backlight control unit 202.

Therefore, the display control unit 170 controls the generation and emission of image light which are performed by the right display driving unit 22 and the left display driving unit 24, respectively. For example, the display control unit 170 causes both the right display driving unit 22 and the left display driving unit 24 to generate image light or cause one of them to generate image light. In addition, the display control unit 170 is capable of causing neither the right display driving unit 22 nor the left display driving unit 24 to generate image light.

In addition, the display control unit 170 transmits a control signal for the right LCD control unit 211 and a control signal for the left LCD control unit 212, respectively, through the transmission unit 51 and the transmission unit 52. In addition, the display control unit 170 transmits a control signal for the right backlight control unit 201 to the right backlight control unit 201 and transmits a control signal for the left backlight control unit 202 to the left backlight control unit 202.

The electrical power control unit 180 transmits and receives the control signal or the control data to and from a battery control unit 330, and performs control according to the remaining power quantity of the first battery 131 and the remaining power quantity of the second battery 132. That is, as will be described later with reference to FIG. 5 and FIGS. 6A to 6D, the electrical power control unit 180 performs a report operation which demands the exchange of the batteries according to the decrease in the remaining power quantity of either or both the first battery 131 and the second battery 132. In addition, the electrical power control unit 180 switches between the normal operation mode and the battery exchange mode according to an operation or the like in the control device 10.

In addition, when the remaining power quantity of the first battery 131 and the remaining power quantity of the second battery 132 are not remarkably small, the electrical power control unit 180 forcibly shuts down the HMD 100. That is, a series of shut-down sequences are executed in order to normally end the function of the HMD 100 by the operating system 150.

The electrical power control unit 180 uses, for example, two values, that is, a preliminarily set warning value and a threshold as conditions for performing the report operation which demands the exchange of the batteries. The warning value is the value of the remaining power quantity of the battery which is a reference to warn and report the decrease in the remaining power quantity, and the threshold is the value of the remaining power quantity of the battery which is a reference to start the execution of the shut-down sequence. The warning value and the threshold may be values which are compared with the sum of the remaining power quantity of the first battery 131 and the remaining power quantity of the second battery 132, and may be values which define the remaining power quantity of the first battery 131 and the remaining power quantity of the second battery 132 respectively. The warning value and the threshold value are stored in the storage unit 120 as setting data 121.

The electrical power control unit 180 reads content data 123 which is stored by the storage unit 120 in the report operation, controls the image processing unit 160 and the display control unit 170, and causes the image display unit 20 to display an AR display image. Meanwhile, when the content data 123 includes the sound data, the electrical power control unit 180 may output the sound of content from the right earphone 32 and the left earphone 34 by controlling the sound processing unit 187.

AR content, which is displayed by the electrical power control unit 180, is a letter or an image which reports the reduction in the remaining power quantity of the battery and demands the exchange of the battery. The electrical power control unit 180 displays the AR content in a state in which the user is watching a target through the image display unit 20. When the electrical power control unit 180 performs AR display in which the image, the letter, or the like is displayed in a location corresponding to the target, the electrical power control unit 180 provides information relevant to the target or changes the visual performance of the target which is viewed through the image display unit 20. The AR content includes data of the image or the letter which is displayed in the location corresponding to the target. In addition, the AR content may include data which specifies the target, data which is relevant to the display location of the image or the letter, or the like. The display location of the AR content may be a location which overlaps the target or the vicinity of the target. The target may be an object, and includes the first battery 131 and the second battery 132 which are exchange targets in the embodiment. A method for detecting a target by the electrical power control unit 180 is arbitrary. However, in the embodiment, the electrical power control unit 180 detects a target, which is located in the visual field of the user, from image data which is imaged by the camera 61. Further, the electrical power control unit 180 determines the display location of the AR content corresponding to the detected target, and displays the AR content.

It is preferable to display the AR content such that the AR content overlaps a location in which the user visually recognizes the target or to display the AR content according to a location in which the target is visually recognized. Therefore, the electrical power control unit 180 detects a target image from the image data which is imaged by the camera 61, and specifies the location of the target in the imaging range of the camera 61 based on the locational relationship between the detected target image and the entire imaged image. The electrical power control unit 180 determines the display location of the AR content corresponding to the location of the target based on the locational relationship between the imaging range of the camera 61 and the display area of the image display unit 20.

The sound processing unit 190 acquires a sound signal which is included in the content, amplifies the acquired sound signal, and supplies the amplified sound signal to a speaker (not shown in the drawing) in the right earphone 32 and a speaker (not shown in the drawing) in the left earphone 34, which are connected to the connection member 46. Meanwhile, for example, when a Dolby (registered trademark) system is used, a process for the sound signal is performed, and, for example, different sounds, in which frequencies or the like are changed, are output from the right earphone 32 and the left earphone 34, respectively.

The image display unit 20 includes an interface 25, a right display driving unit 22, a left display driving unit 24, a right light guiding plate 261 as the right optical image display unit 26, a left light guiding plate 262 as the left optical image display unit 28, the camera 61, a vibration sensor 65, and a 9-axial sensor 66.

The vibration sensor 65 is configured using an acceleration sensor, and is arranged inside the image display unit 20 as illustrated in FIG. 1. In the example of FIG. 1, the vibration sensor 65 is built in the vicinity of the end part ER of the right optical image display unit 26 in the right holding unit 21. When the user performs an operation of patting the end part ER (knocking operation), the vibration sensor 65 detects vibration due to the operation, and outputs the results of detection to the control unit 140. The control unit 140 detects the knocking operation performed by the user according to the results of detection performed by the vibration sensor 65.

The 9-axial sensor 66 is a motion sensor which detects acceleration (3 axes), angular velocity (3 axes), and terrestrial magnetism (3 axes). The 9-axial sensor 66 is provided in the image display unit 20. Therefore, when the image display unit 20 is mounted on the head of the user, it is possible for the control unit 140 to detect the motion of the head of the user based on detected values of the 9-axial sensor 66. The direction of the image display unit 20 is understood based on the detected motion of the head of the user, and thus it is possible for the control unit 140 to estimate a gaze direction of the user.

The interface 25 includes a connector in which the right code 42 is connected to the left code 44. The interface 25 outputs the clock signal PCLK, the vertical synchronizing signal VSync, the horizontal synchronizing signal HSync, and the image data Data, which are transmitted from the transmission unit 51, to relevant reception units (Rx) 53 and 54. In addition, the interface 25 outputs a control signal, which is transmitted from the display control unit 170, to the relevant reception units 53 and 54, the right backlight control unit 201, or the left backlight control unit 202.

In addition, the interface 25 is an interface for the camera 61, the vibration sensor 65 and the 9-axial sensor 66. The results of detection relevant to vibration, which are acquired by the vibration sensor 65, and the results of detection relevant to the acceleration (3 axes), the angular velocity (3 axes), and the terrestrial magnetism (3 axes), which are acquired by the 9-axial sensor 66, are transmitted to the control unit 140 of the control device 10 through the interface 25.

The right display driving unit 22 includes a reception unit 53, a right backlight (BL) control unit 201 and a right backlight (BL) 221 which function as light sources, a right LCD control unit 211, which functions as a display element, a right LCD 241, and a right optical projection system 251. The right backlight control unit 201 and the right backlight 221 function as the light sources. The right LCD control unit 211 and the right LCD 241 function as the display elements. Meanwhile, the right backlight control unit 201, the right LCD control unit 211, the right backlight 221, and the right LCD 241 are collectively referred to as an “image light generation unit”.

The reception unit 53 functions as a receiver for performing serial transmission between the control device 10 and the image display unit 20. The right backlight control unit 201 drives the right backlight 221 based on the input control signal. The right backlight 221 is, for example, a light emitting body such as an LED or electroluminescence (EL). The right LCD control unit 211 drives the right LCD 241 based on the clock signal PCLK, the vertical synchronizing signal VSync, the horizontal synchronizing signal HSync, and the right eye image data Data which are input through the reception unit 53. The right LCD 241 is a transmission-type liquid crystal panel in which a plurality of pixels are arranged in a matrix shape.

The right optical projection system 251 is formed of a collimating lens which causes image light emitted from the right LCD 241 to be light flux in a parallel state. The right light guiding plate 261, which functions as the right optical image display unit 26, guides image light, which is output from the right optical projection system 251, to the user right eye RE while causing the image light to be reflected along a prescribed light path.

The left display driving unit 24 has the same configuration as the right display driving unit 22. The left display driving unit 24 includes a reception unit 54, a left backlight (BL) control unit 202 and a left backlight (BL) 222 which function as light sources, a left LCD control unit 212, which functions as a display element, a left LCD 242, and a left optical projection system 252. The left backlight control unit 202 and the left backlight 222 function as the light sources. The left LCD control unit 212 and the left LCD 242 function as the display elements. In addition, the left optical projection system 252 is formed of a collimating lens which causes image light emitted from the left LCD 242 to be light flux in a parallel state. The left light guiding plate 262, which functions as the left optical image display unit 28, guides image light, which is output from the left optical projection system 252, to the user left eye LE while causing the image light to be reflected along a prescribed light path.

The control device 10 includes the power source unit 300 as the power source of the HMD 100. The power source unit 300 includes a first battery 131 and a second battery 132 which supply electrical power. In addition, the power source unit 300 includes a battery control unit 330 which controls the supply of electrical power from the first battery 131 and the second battery 132. The power source unit 300 supplies the electrical power of the first battery 131 and the second battery 132 to each of the units of the HMD 100 through a power supply unit 137 (electrical power supply unit). The battery control unit 330 is connected to the control unit 140.

The power supply unit 137 is connected to each of the units included in the control device 10, and is further connected to the image display unit 20 by the connection unit 40. The power supply unit 137 supplies direct current to the control device 10 and the image display unit 20.

Although the first battery 131 and the second battery 132 are a secondary battery which can be charged, it is possible to use a primary battery as a configuration in which a charging operation which will be described later is not performed.

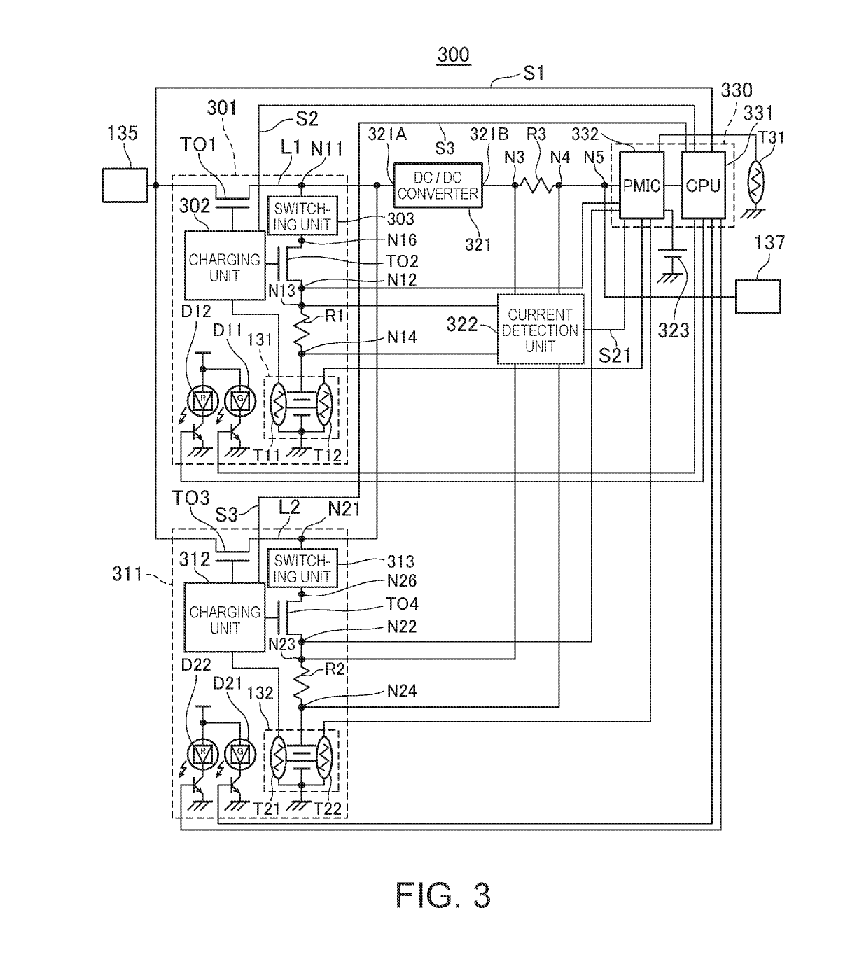

FIG. 3 is a circuit diagram illustrating the configuration of the power source unit 300 in detail. The circuit diagram illustrated in FIG. 3 illustrates an example of the detailed configuration of the power source unit 300, and it is apparent that it is possible to replace a part or the entirety of the circuit illustrated in FIG. 3 with an equivalent circuit or a circuit which has the same functions.

As illustrated in FIG. 3, the power source unit 300 includes a DC connector 135. In the DC connector 135, it is possible to connect an external AC adapter (not shown in the drawing), and it is possible to receive the supply of electrical power for driving the HMD 100 from the AC adapter and the supply of electrical power for changing the first battery 131 and the second battery 132.

The power source unit 300 includes a first power source unit 301 which includes the first battery 131, and a second power source unit 311 which includes the second battery 132. In addition, the power source unit 300 includes a DC/DC converter 321, a current detection unit 322, and a sub battery 323.

The battery control unit 330 includes a Power Management Integrated Circuit (PMIC: power source control IC) 332 which detects the state of each of the units of the power source unit 300, and a CPU 331 which controls each of the units of the power source unit 300. The CPU 331 is connected to the DC connector 135, and is capable of detecting the voltage of the DC connector 135.

The DC/DC converter 321 performs conversion on a voltage of direct current which is supplied from the DC connector 135, the first power source unit 301, and the second power source unit 311, and outputs the resulting voltage to the power supply unit 137. The input terminal 321A of the DC/DC converter 321 is connected to feed lines L1 and L2. The feed line L1 connects the DC connector 135 and the first power source unit 301 to the DC/DC converter 321. The feed line L2 connects the DC connector 135 and the second power source unit 311 to the DC/DC converter 321.

The current detection unit 322 detects current which flows through the first power source unit 301, the second power source unit 311, and the DC/DC converter 321 as will be described later. The current detection unit 322 transmits and receives a control signal S21 between the current detection unit 322 and the PMIC 332 and transmits the results of detection to the PMIC 332.

The PMIC 332 acquires the results of voltage and current detection performed by the current detection unit 322. In addition, the PMIC 332 detects the temperatures of the first battery 131 and the second battery 132, the output voltage of the DC/DC converter 321, and the output voltages of the first battery 131 and the second battery 132. In addition, the PMIC 332 is connected with the thermistor T31 of a main substrate (not shown in the drawing) on which the control unit 140 of the control device 10 (FIG. 2) is mounted, and the PMIC 332 detects the temperature of the main substrate. The PMIC 332 outputs the results of detection to the CPU 331. The PMIC 332 is connected with the sub battery 323 which functions as a backup power source. When the remaining power quantity of the first battery 131 and the remaining power quantity of the second battery 132 are extremely small, the PMIC 332 operates using the sub battery 323, and supplies the electrical power of the sub battery 323 to the CPU 331.

The CPU 331 is connected to a charging unit 302 which is included in the first power source unit 301, and a charging unit 312 which is included in the second power source unit 311, and controls each of the charging units 302 and 312.

In addition, the CPU 331 calculates the remaining power quantity of the first battery 131 and the remaining power quantity of the second battery 132 based on the output voltages of the first battery 131, the second battery 132, and the DC/DC converter 321 which are detected by the PMIC 332, and outputs the calculated remaining power quantities to the control unit 140.

The CPU 331 outputs the results of detection for temperatures of the respective units, which are detected by the PMIC 332, or the results of determination about whether or not the detected temperatures are higher than the preset threshold to the control unit 140.

The first power source unit 301 includes a FET_T01 and a FET_T02, and the charging unit 302 which switches between ON/OFF of the FET_T01 and the FET_T02.

The FET_T01 and the FET_T02 are switching elements which are formed of a Field Effect Transistor (FET). The FET_T02 is provided between the first battery 131 and the node N11 of the feed line L1, and connects the first battery 131 to the feed line L1. The FET_T01 is provided between the DC connector 135 and the node N11 of the feed line L1, and connects the DC connector 135 to the first battery 131.

The charging unit 302 turns on or off the FET_T01 and the FET_T02 respectively according to a control signal S2 which is input from the CPU 331.

When the FET_T01 is turned on, the DC connector 135 is connected to the input terminal 321A of the DC/DC converter 321. When the DC connector 135 is connected to the AC adapter (not shown in the drawing), it is possible to supply electrical power from the AC adapter to the DC connector 135. In addition, it is possible to supply electrical power from the AC adapter to the first battery 131. Therefore, when the FET_T02 is turned on in this state, it is possible to charge the first battery 131.

A switching unit 303 is provided between the first battery 131 and the node N11 on the feed line L1. It is possible to form the switching unit 303 using a power source control element which is generally known as an ORing controller. The switching unit 303 functions as a switch which is turned on or off according to the potential difference between the node N11 and a node N16 on the side of the first battery 131. Specifically, when the potential of the node N11 is lower than the potential of the node N16, the switching unit 303 is turned on, and connects the first battery 131 to the feed line L1.

When the CPU 331 controls the charging unit 302 such that the FET_T01 is turned off and the FET_T02 is turned on and when the remaining power quantity of the electrical power of the first battery 131 is sufficient, the switching unit 303 is turned on. If so, the first battery 131 is connected to the feed line L1, and direct current is input from the first battery 131 to the DC/DC converter 321. Therefore, electrical power, which is supplied by the first battery 131, is supplied to each of the units of the HMD 100 through the power supply unit 137. That is, the first battery 131 becomes the power source of the HMD 100.

The second power source unit 311 includes a FET_T03, a FET_T04, and the charging unit 312 which switches on or off the FET_T03 and the FET_T04.

The FET_T03 and the FET_T04 are formed of a FET as the same as the FET_T01 and the FET_T02. The FET_T04 is provided between the second battery 132 and the node N21 of the feed line L2, and connects the second battery 132 to the feed line L2. The FET_T03 is provided between the DC connector 135 and the node N21 of the feed line L2, and connects the DC connector 135 to the second battery 132.

The charging unit 312 turns on or off each of the FET_T03 and the FET_T04 according to a control signal S3 which is input from the CPU 331.

When the FET_T03 is turned on, the DC connector 135 is connected to the DC/DC converter 321. When the DC connector 135 is connected with an AC adapter (not shown in the drawing), it is possible to supply electrical power from the AC adapter to the DC connector 135. In addition, since it is possible to supply electrical power from the AC adapter to the second battery 132, it is possible to charge the second battery 132 when the FET_T04 is turned on in this state.

The switching unit 313 is provided between the second battery 132 and the node N21 on the feed line L2. It is possible to form the switching unit 313 using the ORing controller as the same as the switching unit 303, and functions as a switch which is turned on or off according to the potential difference between the node N21 and a node N26 on the side of the second battery 132. Specifically, when the potential of the node N21 is lower than the potential of the node N26, the switching unit 313 is turned on and connects the second battery 132 to the feed line L2.

When the CPU 331 controls the charging unit 312 such that the FET_T03 is turned off and the FET_T04 is turned on and when the remaining power quantity of the electrical power of the second battery 132 is sufficient, the switching unit 303 is turned on. If so, the second battery 132 is connected to the feed line L2, and direct current is input from the second battery 132 to the DC/DC converter 321. Therefore, electrical power, which is supplied by the second battery 132, is supplied to each of the units of the HMD 100 through the power supply unit 137. That is, the second battery 132 becomes the power source of the HMD 100.

Thermistors T11 and T12 are provided in the package of the first battery 131. The thermistor T11 is connected to the charging unit 302, and thus it is possible for the charging unit 302 to monitor the temperature of the first battery 131. In addition, the thermistor T12 is connected to the PMIC 332, and thus it is possible for the PMIC 332 to monitor the temperature of the first battery 131.

Thermistors T21 and T22 are provided in the package of the second battery 132. The thermistor T21 is connected to the charging unit 312, and thus it is possible for the charging unit 312 to monitor the temperature of the second battery 132. In addition, the thermistor T22 is connected to the PMIC 332, and thus it is possible for the PMIC 332 to monitor the temperature of the second battery 132.

The first power source unit 301 includes an LED_D11 which emits light in green color, and an LED_D12 which emits light in red color. The LED_D11 and the LED_D12 are respectively caused to light on under the control of the CPU 331. The CPU 331 causes the respective LED_D11 and LED_D12 to light on, light off, and flicker according to the state of the remaining power quantity of the first battery 131 under the control of the control unit 140.

The second power source unit 311 includes an LED_D21 which emits light in green color, and an LED_D22 which emits light in red color. The LED_D21 and the LED_D22 are respectively caused to light on under the control of the CPU 331. The CPU 331 causes the respective LED_D21 and LED_D22 to light on, light off, and flicker according to the state of the remaining power quantity of the second battery 132 under the control of the control unit 140.

A register R1 is connected between the first battery 131 and the FET_T02. A node N13 and a node N14 on both ends of the resistor R1 are respectively connected to the current detection unit 322. The current detection unit 322 detects current which is input and output to and from the first battery 131 based on the potential difference between the node N13 and the node N14.

A resistor R2 is connected between the second battery 132 and the FET_T04. A node N23 and a node N24 on both ends of the resistor R2 are respectively connected to the current detection unit 322. The current detection unit 322 detects current which is input and output to and from the second battery 132 based on the potential difference between the node N23 and the node N24.

Further, a resistor R3 is connected between the output terminal 321B of the DC/DC converter 321 and the power supply unit 137, and the current detection unit 322 is connected to a node N3 and a node N4 on both the ends of the resistor R3. The current detection unit 322 detects current which is output from the DC/DC converter 321 based on the potential difference between the node N3 and the node N4.

The results of current detection performed by the current detection unit 322 are output to the PMIC 332, and are used for the control of the CPU 331.

The PMIC 332 is connected to the node N12 which is the end part of the resistor R1, the node N22 which is the end part of the resistor R2, and a node N5 which is the end part of the resistor R3. The PMIC 332 detects the output voltage of the first battery 131 in the node N12, the output voltage of the second battery 132 in the node N22, and the output voltage of the DC/DC converter 321 in the node N5.

In this case, the resistances of the resistors R1 and R2 are the same and the voltage drops of the FET_T02 and the FET_T04 are the same in the first power source unit 301 and the charging unit 302.

In the power source unit 300, the CPU 331 controls the charging units 302 and 312, and thus it is possible to supply electrical power by individually connecting the first battery 131 and the second battery 132 to the DC/DC converter 321. When both the first battery 131 and the second battery 132 are connected to the DC/DC converter 321, electrical power is supplied to the first battery 131 and the second battery 132 from the side in which the remaining power quantity is large.

That is, in a state in which the FET_T02 and the FET_T04 are turned on, the input terminal 321A of the DC/DC converter 321 is connected with both the first battery 131 and the second battery 132 through the feed lines L1 and L2. The potential of the feed line L1 is the same as the potential of the feed line L2, and the potential is determined by a voltage on a side in which an output voltage is higher in the first battery 131 and the second battery 132.

When the remaining power quantity of the first battery 131 is different from the remaining power quantity of the second battery 132, the output voltage of the first battery 131 is different from the output voltage of the second battery 132. When the remaining power quantity of the first battery 131 is larger than the remaining power quantity of the second battery 132, the switching unit 313 is turned off because the potential of the node N26 is lower than the potential of the feed line L2. Therefore, electrical power is supplied from the first battery 131 to the DC/DC converter 321. When the remaining power quantity of the second battery 132 is larger than the remaining power quantity of the first battery 131, the switching unit 303 is turned off in the same manner, with the result that the first battery 131 is separated from the feed line L1, and thus the second battery 132 supplies electrical power.

As described above, it is possible for the power source unit 300 to supply power from both the first battery 131 and the second battery 132, and it is possible to supply power if the remaining power quantities of two batteries 131 and 132 are not zero. In addition, it is possible for the control unit 140, which is connected to the power source unit 300, to individually acquire the remaining power quantity of the first battery 131 and the remaining power quantity of the second battery 132 from the CPU 331. In addition, it is possible for the control device 10 to control the temperature of the main substrate, the temperature of the first battery 131, and the temperature of the second battery 132, as necessary.

In addition, the control unit 140 causes the charging units 302 and 312 to operate under the control of the CPU 331, and thus it is possible to charge the first battery 131 and the second battery 132 in a state in which the DC connector 135 is connected with the AC adapter.

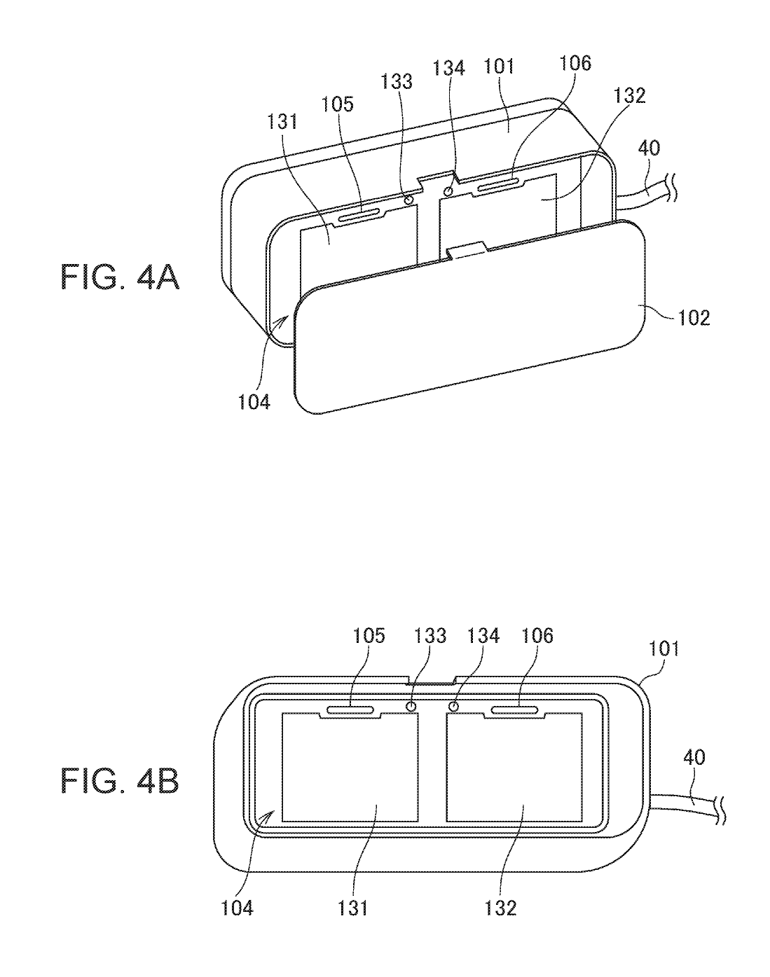

FIGS. 4A and 4B are diagrams illustrating the appearances of the main body of the control device 101, and particularly illustrating a state in which the first battery 131 and the second battery 132 are received in the main body of the control device 101. FIG. 4A illustrates a state in which a battery cover 102 is mounted, and FIG. 4B illustrates a state in which the battery cover 102 is detached.

The main body of the control device 101 is approximately a square case in which each of the units of the control device 10 illustrated in FIG. 2 is stored. As illustrated in FIG. 1, the determination key 11, the lighting part 12, the display switching key 13, the track pad 14, the brightness switching key 15, the direction key 16, the menu keys 17, and the power source switch 18 are arranged on the front surface of the main body of the control device 101. FIGS. 4A and 4B illustrate the back side of the main body of the control device 101.

The back surface of the main body of the control device 101 is covered by the battery cover 102. When the battery cover 102 is detached, the battery storage unit 104 opens as illustrated in FIG. 4A, and thus it is possible for the battery storage unit 104 to access the first battery 131 and the second battery 132.

As illustrated in FIGS. 4A and 4B, the first battery 131 and the second battery 132 are stored in the battery storage unit 104 in a row. The first battery 131 is locked by a locking unit 105, and the second battery 132 is locked by a locking unit 106. When an operation of pressing the locking units 105 and 106 is performed, it is possible to extract the first battery 131 and the second battery 132 form the battery storage unit 104, respectively.

In addition, the LED display unit 133 is arranged in the vicinity of the locking unit 105. The LED display unit 133 is equipped with the LED_D11 and the LED_D12 of the power source unit 300 (FIG. 3), and causes light which is emitted from the LED_D11 and the LED_D12 to be transmitted. The LED display unit 134 is arranged in the vicinity of the locking unit 106. The LED display unit 134 is equipped with the LED_D21 and the LED_D22 of the power source unit 300 and causes light which is emitted from the LED_D21 and the LED_D22 to be transmitted.

As described above, the LED_D11 and the LED_D12 light on and flicker under the control of the CPU 331 (FIG. 2). In addition, the LED_D21 and the LED_D22 light on and flicker under the control of the CPU 331. The LED display units 133 and 134 function as display units which guide the user, for example, when the first battery 131 and the second battery 132 are exchanged.

The electrical power control unit 180 (FIG. 2) detects the remaining power quantity of the first battery 131 and the remaining power quantity of the second battery 132 by the function of the battery control unit 330. Further, when the remaining power quantity of the first battery 131 and the remaining power quantity of the second battery 132 are small, the exchange of the first battery 131 or the second battery 132 is guided based on the display performed by the image display unit 20 and the light-on state of the LED display units 133 and 134.

As described above, the power source unit 300 is configured such that electrical power is supplied from one of the first battery 131 and the second battery 132 which has a larger remaining power quantity. Therefore, the electrical power of the first battery 131 and the electrical power of the second battery 132 are approximately equally consumed, and thus it is difficult that a state in which the remaining power quantity of one of the batteries is small and the remaining power quantity of the remaining battery is large occurs. Accordingly, in the description below, a case in which both the remaining power quantity of the first battery 131 and the remaining power quantity of the second battery 132 decrease will be described as an example. It is possible for the HMD 100 to individually detect the remaining power quantity of the first battery 131 and the remaining power quantity of the second battery 132 using the battery control unit 330. Therefore, when the remaining power quantity of one of the first battery 131 and the second battery 132 is reduced, it is possible to provide guidance.

FIG. 5 is an explanatory diagram illustrating the transition of the state of the HMD 100, and illustrates an association between the change in the remaining power quantity of the first battery 131 and the remaining power quantity of the second battery 132 and the change in the state and the operation of the HMD 100. In addition, FIGS. 6A, 6B, 6C, and 6D are diagrams illustrating examples of display of the image display unit 20, and illustrate a visual range VR of the user.

In FIG. 5, an operation which is performed by the user of the HMD 100 is referred to as a “user operation”, and the display form of the remaining power quantity of the battery in the image display unit 20 is referred to as the “remaining power quantity of the battery display”. In an operation which displays the remaining power quantity of the battery, the image display unit 20 functions as a remaining power quantity display unit. In addition, the remaining power quantity of the first battery 131 is referred to as “the remaining power quantity of the battery (1)” and the remaining power quantity of the second battery 132 is referred to as “the remaining power quantity of the battery (2)”. The light-on state of the LED display unit 133 is referred to as an “LED (1)”, the light-on state of the LED display unit 134 is referred to as an “LED (2)”, the operation of the HMD 100 is referred to as a “system-side operation”, and the AR display in the image display unit 20 is referred to as “AR display”.

FIG. 5 illustrates an example of the transition of a state (state 1) in which the remaining power quantity of the first battery 131 and the remaining power quantity of the second battery 132 are 100% is set to a start state. The example shows a procedure in which the remaining power quantity of the first battery 131 and the remaining power quantity of the second battery 132 decrease, and further shows a progress up to a state (state 9) after the first battery 131 and the second battery 132 are exchanged. The vertical direction of FIG. 5 corresponds to the passage of time (change in the state).

The state 1 is a state in which the first battery 131 and the second battery 132 are approximately fully charged, and thus the remaining power quantity is 100%. In the state 1, the HMD 100 performs a normal operation of displaying an image in accordance with an operation in the control device 10.

As illustrated in FIG. 6A, a display area 401 which is arranged in a user's visual range VR is provided with an information display unit 402. The information display unit 402 is an area in which a mark, an icon, a letter, a message or the like relevant to the remaining power quantity of the battery is displayed, and is arranged at the bottom of the display area 401 such that the visual recognition of the visual range VR is not obstructed. At the left terminal of the information display unit 402, a battery mark which indicates the remaining power quantity of the first battery 131 and the remaining power quantity of the second battery 132 is arranged. The battery mark is a display unit which indicates the remaining power quantity of the battery in stages (for example, 10 stages). In state 1, a level 10 which corresponds to a remaining power quantity of 100% (all indicators display color) is shown as illustrated in FIG. 6A.

Meanwhile, in the information display unit 402, a single mark which displays the sum of the remaining power quantity of the first battery 131 and the remaining power quantity of the second battery 132 may be arranged. In addition, in the information display unit 402, a battery mark which displays the remaining power quantity of the first battery 131 and a battery mark which displays the remaining power quantity of the second battery 132 may be arranged.

The battery mark indicates the whole remaining power quantity of the battery of the HMD 100, and displays the sum of the remaining power quantity of the first battery 131 and the remaining power quantity of the second battery 132. In the embodiment, it is assumed that the capacity of the first battery 131 is approximately the same as the capacity of the second battery 132.

In states 2 and 3, the display of the battery mark of the information display unit 402 changes in accordance with the reduction in the remaining power quantity of the first battery 131 and the remaining power quantity of the second battery 132. However, the HMD 100 performs the normal operation. The battery mark is displayed in such a way that the electrical power control unit 180 controls the image processing unit 160, and the electrical power control unit 180 controls the change in the display of the battery mark.

In state 4, both the remaining power quantity of the first battery 131 and the remaining power quantity of the second battery 132 become 20%, and thus the electrical power control unit 180 performs the report operation. The electrical power control unit 180 causes the battery mark of the information display unit 402 to be displayed at a level 1. Further, the electrical power control unit 180 causes the battery mark of the information display unit 402 to flicker.

When the remaining power quantity of the battery is further reduced, the process proceeds to state 5. It is possible for a user to perform a normal operation in state 5.

In state 5, the remaining power quantity of the first battery 131 and the remaining power quantity of the second battery 132 respectively become 10%, and thus the electrical power control unit 180 performs the report operation. In the report operation, the battery mark of the information display unit 402 is set to a level 0. In addition, the display of the battery mark through flicker is continued, and guidance display for demanding that the battery be exchanged is performed on the information display unit 402. Further, the LED display unit 133 is caused to be a red flicker state, and the LED display unit 134 is caused to be a red lighting state.

In state 5, both the remaining power quantity of the first battery 131 and the remaining power quantity of the second battery 132 are 10%, it is preferable to exchange both the batteries. However, when the first battery 131 and the second battery 132 are detached at the same time, there is a problem in that the operation of the HMD 100 may be interfered. Therefore, when the electrical power control unit 180 guides the exchange of the battery, the electrical power control unit 180 removes one or more batteries of the first battery 131 and the second battery 132, and guides the exchange of another battery. For example, the exchange of one battery of the first battery 131 and the second battery 132 is guided, and the exchange of the other battery is not guided. Further, a fact that the degree of emergency on the side in which the exchange is guided is high is shown. In state 5, the electrical power control unit 180 causes the LED display unit 133 to flicker with red. Therefore, when the user opens the battery cover 102 (FIG. 4A), it is possible to guide that the first battery 131 should be preferentially exchanged rather than the second battery 132.

FIG. 6B illustrates an example of display in state 5. In the information display unit 402, the battery mark flickers, and a message of letters for demanding that the battery should be exchanged is displayed.

In state 5, when the user operates the control device 10 in order to instruct to transition to the battery exchange mode in which a battery is exchanged, the HMD 100 is transitioned to state 6.

In state 6, as illustrated in FIG. 6C, animation, which describes an operation of exchanging the first battery 131, is displayed in the display area 401. According to the change in display of the animation, it is possible to describe a procedure from detaching the first battery 131 to mounting a new first battery 131, and thus it is possible to easily guide the operation.

Further, when the electrical power control unit 180 detects that the user detaches the information display unit 402 and watches the back surface of the main body of the control device 101, the electrical power control unit 180 performs the AR display. In the AR display, the electrical power control unit 180 displays a message such that the message overlaps with the first battery 131 and the second battery 132 which are shown in the visual range VR.

In FIG. 6C, in a state in which the battery storage unit 104 can be visually recognized in the visual range VR, the flicker state of the LED display unit 133 is visually recognized. The electrical power control unit 180 arranges the AR display unit 405 to be seen by overlapping the first battery 131 based on the relationship between the location of the display area 401 and the location in which the battery storage unit 104 is visually recognized. The AR display unit 405 is an area in which AR display is performed on letters or images. In FIG. 6C, a letter message which guides exchange is displayed.

Here, when the first battery 131 is exchanged by the user, the HMD 100 is transitioned to state 7. In state 7, the remaining power quantity of the first battery 131 is recovered, and thus the display of the remaining power quantity of the battery mark and the display of the LED display unit 133 change. Particularly, the LED display unit 133 lights on with green color in order to display that the capacity of the first battery 131 acquired after the exchange is normal.

In state 7, the electrical power control unit 180 causes the LED display unit 134 to be in a red flickering state and causes an animation which describes the operation of exchanging the second battery 132 to be displayed, as illustrated in FIG. 6D, as a report operation which demands that the second battery 132 should be exchanged.

Further, AR display is performed for a message, which demands that the second battery 132 should be exchanged, such that the message overlaps the battery storage unit 104 which is visually recognized in the visual range VR. In addition, a message which indicates that the exchange of the first battery 131 is completed may be displayed.

Thereafter, when the second battery 132 is exchanged, the HMD 100 is transitioned to state 8, and the electrical power control unit 180 lights on the LED display unit 133 and the LED display unit 134 with green color. In addition, the electrical power control unit 180 performs AR display for a message which indicates that exchange is completed for the exchanged first battery 131 and the second battery 132. Here, the electrical power control unit 180 ends the battery exchange mode and returns to the normal operation, and the HMD 100 is transitioned to state 10.

Meanwhile, when the power source unit 300 unequally consumes the electrical power of the first battery 131 and the second battery 132, the electrical power control unit 180 may perform the operations which are described in states 5 to 7 when the remaining power quantity of any one of the batteries is reduced.

As described above, it is possible for the electrical power control unit 180 to cause the image display unit 20 to perform guidance display according to the reduction in the remaining power quantity of any one or both of the first battery 131 and the second battery 132. The guidance display includes a letter message or an image, and it is possible for the user to perform display using AR display in which the letter message or the image overlaps an external view that is visually recognized after transmitting the right optical image display unit 26 and the left optical image display unit 28. In addition, the electrical power control unit 180 displays the message by the AR display in synchronization with the light-on and flicker of the LED display units 133 and 134, and thus it is possible to perform further effective report.

According to information which is displayed in states 5 to 8, it is possible for the control unit 140 to guide the exchange procedure, for example, without detaching all of the first battery 131 and the second battery 132. In this case, when all of the plurality of batteries (the first battery 131 and the second battery 132) which are included in the HMD 100 are in states which require exchange, the user performs exchange without turning off the power source of the HMD 100, that is, without stopping the HMD 100. Therefore, there is no case in which the HMD 100 stops even when the user does not understand the procedure of exchanging the batteries.

Further, when the time which is necessary for the user to exchange a battery becomes long because the exchange procedure and the guidance of the battery exchange procedure of the first battery 131 and the second battery 132 are displayed in accordance with each of the remaining power quantity of the first battery 131 and the remaining power quantity of the second battery 132, it is possible to complete exchange without stopping the HMD 100.

In addition, a display mode, which is displayed on the image display unit 20 as the remaining power quantity display unit, may display at least any one of the remaining power quantity of the first battery 131 and the remaining power quantity of the second battery 132, or may display based on the average of the remaining power quantity of the first battery 131 and the remaining quantity of the second battery 132.

It is possible to use the information which is displayed in states 5 to 7 as guidance information which guides the necessity for exchange of the first battery 131 and the second battery 132, the exchange procedure, the method of the exchange operation, the time in which it is possible to continuously use the first battery 131 and the second battery 132, or the like. In addition, it is possible to use the information as, for example, internal information which includes state information of the remaining power quantity of the first battery 131 and the remaining power quantity of the second battery 132.

Before the guidance information, the internal information, or the like is displayed, a menu image for selecting display may be displayed. When an item, which is included in the menu image, is selected through an operation performed by the operating unit 111, the selected information may be displayed.

In addition, in state 5, before the exchange mode is selected, the remaining time in which the HMD 100 can be operated may be displayed without performing exchange by adding each of or both the first battery 131 and the second battery 132. The display during the remaining time (available time) in which the operation is possible may be continuously performed until when the exchange of the first battery 131 and the second battery 132 is completed, that is, until the exchange mode ends in state 9.

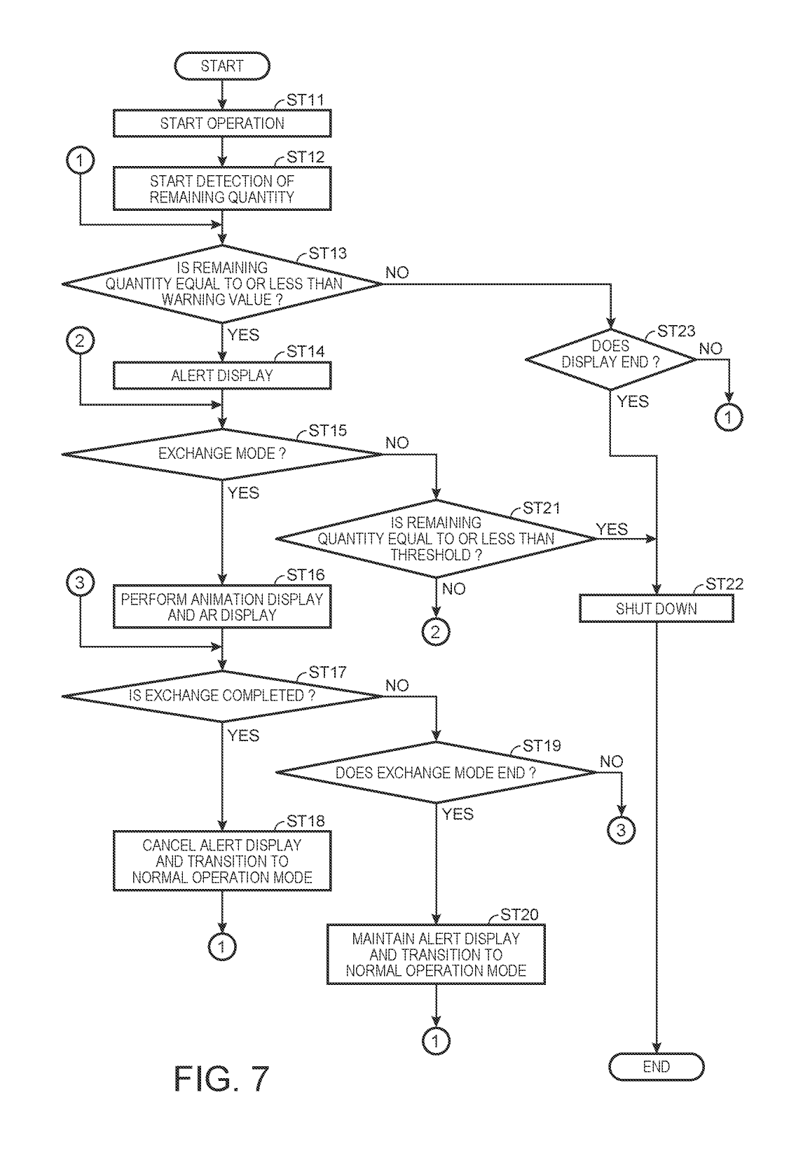

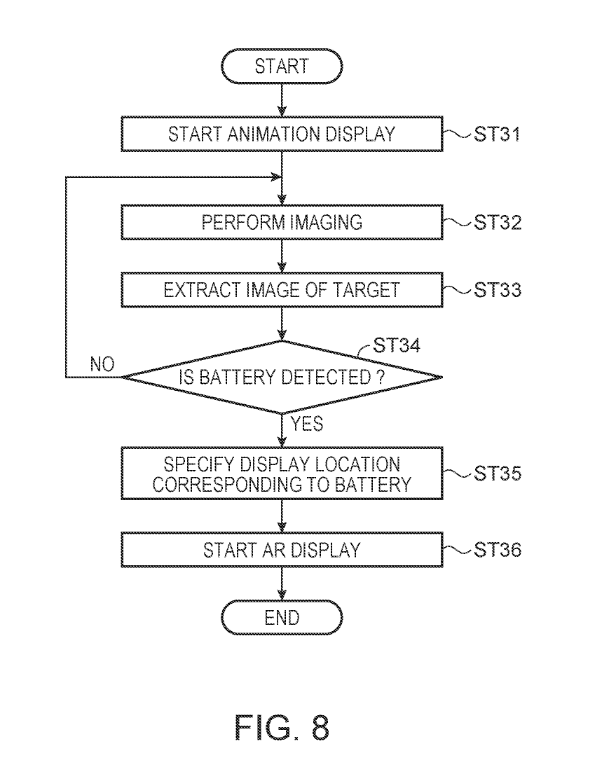

FIGS. 7 and 8 are flowcharts illustrating the operation of the HMD 100. Specifically, FIG. 7 illustrates an operation relevant to the remaining power quantity of the battery of the power source unit 300. FIG. 8 illustrates an operation which is performed when the AR display starts.

When the HMD 100 starts the operation (step ST11), the electrical power control unit 180 is connected to the battery control unit 330, and starts the detection of the remaining power quantity of the first battery 131 and the remaining power quantity of the second battery 132 (step ST12).

The electrical power control unit 180 determines whether or not the sum of the remaining power quantity of the first battery 131 and the remaining power quantity of the second battery 132 is equal to or less than a warning value which is included in the setting data 121 (step ST13). When the remaining power quantity is equal to or less than the warning value (YES in step ST13), the electrical power control unit 180 performs alert display for notifying that the remaining power quantity of the battery is small (step ST14). The alert display corresponds to, for example, the flicker of the battery mark in state 4 of FIG. 5 or the display for guiding the battery exchange in state 5.

Thereafter, the electrical power control unit 180 determines whether or not to transition to the battery exchange mode by the operation performed by the control device 10 (step ST15). When there is an instruction to transition to the battery exchange mode (YES in step ST15), the electrical power control unit 180 transitions to the battery exchange mode, and performs, for example, the animation display and the AR display in state 6 (step ST16). Thereafter, it is determined whether or not a battery, which requires exchange, is exchanged from the first battery 131 and the second battery 132 (step ST17). When the battery is exchanged (YES in step ST17), the electrical power control unit 180 cancels the alert display and returns to the normal operation mode (step ST18), and then returns to step ST13.

In contrast, when the battery, which requires exchange, is not completely exchanged (NO in step ST17), the electrical power control unit 180 determines whether or not the end of the battery exchange mode is instructed (step ST19). When the end of the battery exchange mode is instructed (YES in step ST19), the electrical power control unit 180 maintains the alert display and returns to the normal operation mode (step ST20), and then returns to step ST13. Therefore, for example, when it is not possible to exchange the battery, the process returns to the normal operation mode without exchanging the battery, and thus it is possible for the user to continue the operation. In addition, in this case, the alert display is maintained, and thus there is not a case in which the user forgets to exchange the battery.

In contrast, when it is not instructed to transition to the battery exchange mode (NO in step ST15), the electrical power control unit 180 determines whether or not the sum of the first battery 131 and the second battery 132 is equal to or less than the threshold (step ST21). When the remaining power quantity of the battery is equal to or less than the threshold which is included in the setting data 121 (YES in step ST21), the electrical power control unit 180 shuts down the HMD 100 (step ST22). That is, the electrical power control unit 180 executes the shut-down sequence of the operating system 150, and causes the HMD 100 to transition to a power source-off state.

In addition, the remaining power quantity of the battery is larger than the threshold which is included in the setting data 121, the electrical power control unit 180 returns to step ST15.

In addition, the sum of the remaining power quantity of the first battery 131 and the remaining power quantity of the second battery 132 is larger than the warning value (No in step ST13), the control unit 140 determines whether or not to end the display operation of the HMD 100 (step ST23). When the display does not end (NO in step ST23), the control unit 140 returns to step ST13. In addition, when the display ends (YES in step ST23), the control unit 140 shuts down in step ST22.

The operation performed by the electrical power control unit 180 in step ST16 of FIG. 7 will be described in detail in FIG. 8.

The electrical power control unit 180 first acquires animation data from the content data 123 which is stored in the storage unit 120, controls the image processing unit 160 and the display control unit 170, and displays animation (step ST31).

Subsequently, the electrical power control unit 180 causes the camera 61 to perform imaging and acquires imaged image data (step ST32). The electrical power control unit 180 extracts the image of a target from the imaged image data (step ST33). The electrical power control unit 180 searches the imaged image data for an image which coincides with the feature of the target and extracts the image using, for example, data (not shown in the drawing) relevant to the feature value which is stored in the storage unit 120.

The electrical power control unit 180 determines whether or not the display area 401 and the images of the first battery 131 and the second battery 132, which are stored in the display area 401, are detected from the imaged image data (step ST34). When the relevant image is not detected (NO in step ST34), the electrical power control unit 180 returns to step ST32. In addition, when the relevant image is detected (YES in step ST34), the electrical power control unit 180 specifies a display location corresponding to the detected target (step ST35), displays AR content based on the content data 123 in the specified display location (step ST36), and ends the process.

As described above, the HMD 100 according to the embodiment of the invention includes the image display unit 20 which causes the user to visually recognize an image and causes the external view to be transmitted. The HMD 100 includes the first battery 131 and the second battery 132. When the remaining power quantity of anyone of the batteries becomes the remaining power quantity which requires exchange, the electrical power control unit 180 maintains the display state of the HMD 100, and displays the guidance information relevant to the HMD 100 to overlap with at least a part of the control device 10, which is visually recognized as the external view, while maintaining the power source of the HMD 100. Therefore, when the image display unit 20 performs display, it is possible for the user to be easily aware that the battery requires exchange. Accordingly, it is possible to rapidly provide the information relevant to battery exchange to the user.

For example, the guidance information includes state information, such as the remaining power quantity relevant to at least a part of the first battery 131 and the second battery 132. In addition, the guidance information includes the guidance display for guiding the necessity for exchange of the first battery 131 and the second battery 132, the exchange procedure, the method of the exchange operation, the time in which it is possible to continuously use the first battery 131 and the second battery 132, or the like may be considered. However, the other information may be used. In addition, a configuration in which the display state in the HMD 100 is maintained when the first battery 131 and the second battery 132 are exchanged is included. However, other configurations may be included.

In addition, at the different point of view, in the HMD 100 according to the embodiment of the invention, when the remaining power quantity of any one of the batteries becomes the remaining power quantity which requires exchange, the electrical power control unit 180 maintains the display state of the HMD 100, and displays the internal information to overlap with at least apart of the control device 10, which is visually recognized as the external view. Therefore, when the image display unit 20 performs display, it is possible for the user to be easily aware that the battery requires exchange. Accordingly, it is possible to rapidly provide the information relevant to battery exchange to the user. For example, state information, such as the remaining power quantity relevant to at least a part of the first battery 131 and the second battery 132, may be provided as the internal information. However, the guidance information may be included.

Further, as illustrated in FIGS. 5 to 8, the HMD 100 maintains the display of the HMD 100 while the first battery 131 and the second battery 132 are exchanged, and thus the user performs battery exchange while referring to the display of the HMD 100. The HMD 100, which includes two batteries, guides a procedure, in which it is possible for the user to exchange the batteries without detaching the two batteries and turning off the power source of the HMD 100, through the guidance display. For example, as described with reference to FIG. 5, even when both the first battery 131 and the second battery 132 are in states which require exchange, there is an advantage in that it is possible for the user to exchange the batteries without stopping the operation of the HMD 100.

In addition, in order to maintain the power source of the HMD 100 to be turned on, when the first battery 131 and the second battery 132 are exchanged, the HMD 100 may include a battery exchange mode, in which the amount of electrical power consumption is lowered, as the operation mode in addition to the normal operation mode. That is, when the exchange mode is selected in state 6 of FIG. 5, the amount of electrical power consumption of the right display driving unit 22 and the left display driving unit 24 may be lowered. For example, a way of turning off the display of any one of the right display driving unit 22 and the left display driving unit 24 may be considered. In the exchange mode in this case, any one of the right display driving unit 22 and the left display driving unit is turned off or stopped, and thus it is possible to effectively suppress the amount of electrical power consumption. In addition, when an organic EL element is used instead of the right LCD 241, the left LCD 242, the right backlight control unit 201, or the left backlight control unit 202, the amount of electrical power consumption may be lowered by suppressing an area which is caused to emit light. In this case, the remaining time in which the operation of the HMD 100 is possible may be calculated and displayed based on the amount of electrical power consumption in the battery exchange mode.

In addition, the HMD 100 includes the image display unit 20 which performs display according to the remaining power quantity of any one of the first battery 131 and the second battery 132. In addition, when the remaining power quantity of any one of the batteries becomes the remaining power quantity which requires exchange, the electrical power control unit 180 causes the image display unit 20 and the LED display units 133 and 134 to perform report display, and causes the image display unit 20 to perform the guidance display for guiding the exchange of the battery which has the remaining power quantity that requires exchange. When display pertaining to the remaining power quantities of the batteries and the guidance display are performed, it is possible for the user to be easily aware that it is necessary to exchange the first battery 131 or the second battery 132. Accordingly, it is possible to rapidly provide the information relevant to battery exchange to the user.

In addition, the electrical power control unit 180 may detect a target which transmits through the image display unit 20 and which is visually recognized by the user, and may perform the AR display on the guidance display in a location which overlaps with the detected target and is visually recognized. Therefore, when the user visually recognizes the target transmitted through the image display unit 20, it is possible to effectively provide the information relevant to battery exchange.

In addition, the HMD 100 includes the power supply unit 137 which supplies electrical power to the HMD 100 by the plurality of batteries (the first battery 131 and the second battery 132) which are included in the power source unit 300. The electrical power control unit 180 determines that the remaining power quantity of any one of the batteries becomes the remaining power quantity which requires exchange based on the total sum of the remaining power quantities of the plurality of batteries. Therefore, it is possible to drive the HMD 100 by effectively using the plurality of batteries of the power source unit 300.

In addition, the electrical power control unit 180 performs guidance display such that the guidance display is synchronized with the change in the display state pertaining to the remaining power quantities of the batteries of the image display unit 20, and thus it is possible to further rapidly securely inform the user that it is necessary to exchange the batteries.

In addition, when it is determined that the plurality of batteries have the remaining power quantities which require exchange, the electrical power control unit 180 causes the image display unit 20 to perform the guidance display for guiding the exchange of anyone of the batteries. For example, when both the first battery 131 and the second battery 132 are demanded to be exchanged and the guidance display pertaining to the exchange of the first battery 131 is performed, the display which demands the exchange of the second battery 132 is not performed. Therefore, it is possible to prevent a non-preferable situation in which all of the plurality of batteries are detached from occurring. That is, it is possible to guide the exchange procedure without detaching all of the first battery 131 and the second battery 132. Therefore, when all of the first battery 131 and the second battery 132, which are included in the HMD 100, are in states which require being exchanged, it is possible for the user to perform exchange without turning off the power source of the HMD 100, that is, without stopping the HMD 100. Therefore, when the user does not fully understand the battery exchange procedure, there is not a case in which the HMD 100 stops.

In addition, the LED display units 133 and 134 are provided to correspond to the first battery 131 and the second battery 132, respectively. The electrical power control unit 180 causes the display states of the LED display units 133 and 134 to be changed based on the respective remaining power quantities of the first battery 131 and the second battery 132. Therefore, it is possible to provide information relevant to the remaining power quantities for the first battery 131 and the second battery 132, respectively, to the user.

Meanwhile, the invention is not limited to the configuration according to the embodiment, and can be realized in various modes in a range which does not depart from the gist of the invention.

For example, in the embodiment, the configuration is described in which the power source unit 300 includes the first battery 131 and the second battery 132. However, the invention is not limited thereto, and the power source unit 300 may include three or more batteries. In addition, when the power source unit 300 includes a plurality of batteries, a primary battery and a secondary battery may be mixed. In this case, the guidance display for demanding exchange may be performed according to the remaining power quantity of the primary battery, and guidance display for demanding to perform charging is performed according to the remaining power quantity of the secondary battery. In addition, a configuration may be provided in which the user can set whether to perform the AR display or the animation display. In addition, the locations in which the first battery 131 and the second battery 132 are stored are not limited to the examples of FIGS. 4A and 4B. For example, the control device 10 may form the power source unit 300. In addition, the remaining power quantity display unit according to the invention is not limited to the LED display units 133 and 134. For example, a liquid crystal display panel may be provided in the control device 10 to display the remaining power quantity. Further, the information display unit 402 of the image display unit 20 may display the remaining power quantity in the form which corresponds to the remaining power quantity display unit.

In addition, for example, an image display unit using another method, such as an image display unit which is mounted like a cap, may be used instead of, for example, the image display unit 20. The image display unit 20 may include a display unit which displays an image for the left eye of the user and a display unit which displays an image for the right eye of the user. In addition, the display apparatus according to the invention may include a head mounted display, which is mounted in, for example, a vehicle or an airplane. In addition, the display apparatus according to the invention may include, for example, a head mounted display which is installed in a body protector, such as a helmet, and a Head-up Display (HUD) which is used for the windshield of a vehicle.

Further, in the embodiment, the configuration in which the image display unit 20 is separated from the control device 10 and both are connected through the connection unit 40 is described as an example. However, a configuration, in which the control device 10 and the image display unit 20 are integrally formed and are mounted on the head of the user, is possible.

In addition, for example, the configuration in which image light is generated in the image display unit 20 may include a configuration which includes an Organic Electro-Luminescence (OEL) display and an organic EL control unit. In addition, it is possible to use a Liquid Crystal on Silicon (LCoS (registered trademark)) or a digital micromirror device as the configuration in which the image light is generated. In addition, it is possible to apply the invention to, for example, a laser retinal projection type head mounted display. That is, a configuration may be used in which the image generation unit includes a laser light source and an optical system, which guides the laser light source to the eyes of the user, and causes the user to visually recognize an image in such away that the retina of the eyes of the user is scanned by causing laser light to be incident onto the eyes of the user and the image is focused on the retina. When the laser retinal projection type head mounted display is used, it is possible to define an “area in which image light can be emitted in the image light generation unit” as an image area which is visually recognized by the eyes of the user.

As an optical system which guides image light to the eyes of the user, a configuration which includes an optical member, which transmits external light that is incident toward the apparatus from the outside, and causes external light to emit to the eyes of the user, together with image light. In addition, an optical member, which is located in front of the eyes of the user and overlaps a part or all of the visual fields of the user, may be used. Further, an optical system may be used in the form of a scanning method for scanning laser light or the like and using laser light as image light. In addition, the invention is not limited to the configuration in which image light is guided in the inside of the optical member, and may only include a function of guiding image light toward the eyes of the user by refracting or reflecting image light toward the eyes of the user.

In addition, it is possible to apply the invention to a display apparatus which uses an optical scanning system using an MEMS mirror and in which an MEMS display technology is used. That is, a signal light forming unit, an optical scanning system which has an MEMS mirror that scans light emitted by the signal light forming unit, and an optical member, in which a virtual image is formed by light which is scanned by the optical scanning system, may be included as the image display elements. In the configuration, light, which is emitted by the signal light forming unit, is reflected on the MEMS mirror, is incident to the optical member, is guided through the inside of the optical member, and reaches the virtual image forming surface. When the MEMS mirror scans light, a virtual image is formed on the virtual image forming surface, the virtual image is grasped by the eyes of the user, and thus the image is recognized. The optical components in this case may guide light through a plurality of reflection similarly to, for example, the right light guiding plate 261 and the left light guiding plate 262 according to the embodiment, or may use a half mirror.

In addition, the display apparatus according to the invention is not limited to the head mounted type display apparatus, and can be applied to various types of display apparatuses such as a flat panel display and a projector. The display apparatus according to the invention may cause an image to be visually recognized by image light together with external light. For example, a configuration, in which an image is visually recognized using image light by the optical member which transmits external light, is provided. In detail, in addition to the configuration in which the head mounted display includes the optical member which transmits the external light, it is possible to apply the invention to a display apparatus which projects image light to a translucent plane surface or curved surface (glass, clear plastic, or the like), which is fixedly or movably installed in a location separated from the user. As an example, a configuration of a display apparatus is provided which projects image light to the window glass of a vehicle, and causes a user who is on the vehicle or a user who is on the outside of the vehicle to visually recognize an internal and external scenes of the vehicle together with an image which is formed by image light. In addition, for example, a configuration of a display apparatus is provided which projects image light to a transparent, semitransparent, or colored transparent display surface, such as the window glass of a building, which is fixedly installed, and causes a user in the vicinity of the display surface to visually recognize a scene through the display surface together with an image formed by image light.

In addition, at least a part of the functional blocks illustrated in FIG. 2 may be realized by hardware, or may be configured to be realized by cooperation of hardware and software, thereby being not limited to a configuration in which independent hardware sources are arranged as illustrated in FIG. 2. In addition, a program which is executed by the control unit 140 may be stored in the storage unit 120 or the storage device of the control device 10, or may be configured such that a program which is stored in an external device is acquired and executed through the communication unit 117 or the interface 125.

In addition, the function of the program which is executed by the control unit 140, that is, each of the processing units (for example, the image processing unit 160, the display control unit 170, the electrical power control unit 180, the sound processing unit 190, and the other generation units, the determination unit, the specifying unit and the like) of the control unit 140 may be formed using Application Specific Integrated Circuit (ASIC) or a System on a Chip (SoC) which is designed to realize the function. In addition, the function may be realized by a programmable device such as a Field-Programmable Gate Array (FPGA).

In addition, from among the configurations which are formed in the control device 10, only the operating unit 111 may be formed as a single User Interface (UI). In addition, the configuration which is formed in the control device 10 may be redundantly formed in the image display unit 20. For example, the control unit 140 illustrated in FIG. 2 may be formed in both the control device 10 and the image display unit 20, or may be configured such that the functions performed by the control unit 140 which is formed in the control device 10 and the CPU which is formed in the image display unit 20 are separately classified.

The entire disclosure of Japanese Patent Application No. 2015-067896, filed Mar. 30, 2015 is expressly incorporated by reference herein.

What is claimed is:

1. A display apparatus, which includes a display unit that causes a user to visually recognize an image and causes an external view to be transmitted, the display apparatus comprising:
a plurality of batteries; and
a control unit that, when a remaining power quantity of any one of the batteries becomes a remaining power quantity which requires exchange, maintains a display state of the display apparatus, and causes the display unit to display guidance information relevant to the display apparatus such that the guidance information overlaps at least a part of the display apparatus, which is visually recognized as the external view, while maintaining a power source of the display apparatus.

2. A display apparatus, which includes a display unit that causes a user to visually recognize an image and causes an external view to be transmitted, the display apparatus comprising:
a battery; and
a control unit that, when a remaining power quantity of the battery becomes a remaining power quantity which requires exchange, maintains a display state of the display apparatus, and causes the display unit to display internal information such that the internal information overlaps at least a part of the display apparatus which is visually recognized as the external view.

3. A display apparatus, which includes a display unit that causes a user to visually recognize an image and causes an external view to be transmitted, the display apparatus comprising:
a plurality of batteries;
a remaining power quantity display unit that performs display according to a remaining power quantity of any one of the batteries; and
a control unit that, when a remaining power quantity of any one of the batteries becomes a remaining power quantity which requires exchange, causes the remaining power quantity display unit to execute report display, and causes the display unit to perform guidance display for guiding exchange of the battery, the remaining power quantity of which requires exchange.

4. The display apparatus according to claim 1,
wherein the control unit detects a target, which transmits through the display unit and is visually recognized by the user, and performs the guidance display in a location which overlaps the detected target and is visually recognized.

5. The display apparatus according to claim 2,
wherein the control unit detects a target, which transmits through the display unit and is visually recognized by the user, and performs the guidance display in a location which overlaps the detected target and is visually recognized.

6. The display apparatus according to claim 3,
wherein the control unit detects a target, which transmits through the display unit and is visually recognized by the user, and performs the guidance display in a location which overlaps the detected target and is visually recognized.

7. The display apparatus according to claim 1, further comprising:
an electrical power supply unit that supplies electrical power to the display apparatus by the plurality of the batteries,
wherein the control unit determines that the remaining power quantity of any one of the batteries becomes the remaining power quantity which requires exchange based on a sum of the remaining power quantities of the plurality of the batteries.

8. The display apparatus according to claim 2, further comprising:
an electrical power supply unit that supplies electrical power to the display apparatus by the plurality of the batteries,
wherein the control unit determines that the remaining power quantity of any one of the batteries becomes the remaining power quantity which requires exchange based on a sum of the remaining power quantities of the plurality of the batteries.

9. The display apparatus according to claim 3, further comprising:
an electrical power supply unit that supplies electrical power to the display apparatus by the plurality of the batteries,
wherein the control unit determines that the remaining power quantity of any one of the batteries becomes the remaining power quantity which requires exchange based on a sum of the remaining power quantities of the plurality of the batteries.

10. The display apparatus according to claim 1,
wherein the control unit causes the display unit to perform the guidance display so as to synchronize with a change in a display state of the remaining power quantity display unit.

11. The display apparatus according to claim 2,
wherein the control unit causes the display unit to perform the guidance display so as to synchronize with a change in a display state of the remaining power quantity display unit.

12. The display apparatus according to claim 3,
wherein the control unit causes the display unit to perform the guidance display so as to synchronize with a change in a display state of the remaining power quantity display unit.

13. The display apparatus according to claim 1,
wherein, when the plurality of the batteries are determined to have the remaining power quantities which require being exchanged, the control unit causes the display unit to perform guidance display for guiding exchange of any one of the batteries.

14. The display apparatus according to claim 2,
wherein, when the plurality of the batteries are determined to have the remaining power quantities which require being exchanged, the control unit causes the display unit to perform guidance display for guiding exchange of any one of the batteries.

15. The display apparatus according to claim 3,
wherein, when the plurality of the batteries are determined to have the remaining power quantities which require being exchanged, the control unit causes the display unit to perform guidance display for guiding exchange of any one of the batteries.

16. The display apparatus according to claim 13,
wherein the remaining power quantity display unit is provided to correspond to each of the plurality of the batteries, and
wherein the control unit changes the display state of the remaining power quantity display unit based on the remaining power quantity of each of the plurality of the batteries.

17. The display apparatus according to claim 14,
wherein the remaining power quantity display unit is provided to correspond to each of the plurality of the batteries, and
wherein the control unit changes the display state of the remaining power quantity display unit based on the remaining power quantity of each of the plurality of the batteries.

18. A method of controlling a display apparatus, which includes a plurality of batteries and a display unit that causes a user to visually recognize an image and causes an external view to be transmitted, the method comprising:
when a remaining power quantity of any one of the batteries becomes a remaining power quantity which requires exchange, maintaining a display state of the display apparatus, and causing the display unit to display guidance information relevant to the display apparatus such that the guidance information overlaps at least apart of the display apparatus, which is visually recognized as the external view, while maintaining a power source of the display apparatus.

19. A method of controlling a display apparatus, which includes a plurality of batteries and a display unit that causes a user to visually recognize an image and causes an external view to be transmitted, the method comprising:
when remaining power quantities of the batteries become remaining power quantities which require being exchanged, maintaining a display state of the display apparatus, and causing the display unit to display internal information such that the internal information overlaps at least a part of the display apparatus which is visually recognized as the external view.

20. A method of controlling a display apparatus, which includes a plurality of batteries, a remaining power quantity display unit that performs display according to a remaining power quantity of any one of the batteries, and a display unit that causes a user to visually recognize an image and causes an external view to be transmitted, the method comprising:
when a remaining power quantity of any one of the batteries becomes a remaining power quantity which requires exchange, causing the remaining power quantity display unit to execute report display, and causing the display unit to perform guidance display for guiding exchange of the battery, the remaining power quantity of which requires exchange.
